(19) United States
(12) Patent Application Publication
(10) Pub. No.: US 2022/0312685 A1
(43) Pub. Date: Oct. 6, 2022

(54) APPARATUS FOR PRODUCING NEGATIVE AIR IONS

(71) Applicant: ZERO2.5 BIOTECH PTE. LTD., Singapore (SG)

(72) Inventors: Swain STEPHEN, Singapore (SG); Hean Chuan FONG, Singapore (SG); Ali MA, Singapore (SG)

(73) Assignee: ZERO2.5 BIOTECH PTE. LTD., Singapore (SG)

(21) Appl. No.: 17/641,459

(22) PCT Filed: Sep. 8, 2020
(86) PCT No.: PCT/SG2020/050521

§ 371 Date: Mar. 9, 2022

(30) Foreign Application Priority Data
Sep. 9, 2019 (SG) 10201908299P
Sep. 9, 2019 (SG) 10201908308V

(51) Int. Cl. A01G 7/04; H01T 23/00

(52) U.S. Cl. CPC A01G 7/04; H01T 23/00; H02M 7/06

(57) ABSTRACT

The present disclosure relates to an apparatus for producing negative air ions from a plant, comprising: —a power supply module; a voltage pulse module connectable to the power supply module, the power supply module being configured to provide a pre-determined input voltage V_{IN} to the voltage pulse module for generating a negative voltage pulse, and to adjust a reflected voltage pulse from the voltage pulse module; and a stimulating probe connected to the voltage pulse module and configured to transmit the negative voltage pulse to a root portion of the plant. The present disclosure also relates to a power supply device for use with the apparatus for producing negative air ions from a plant.

### FIELD

The present disclosure relates to an apparatus for producing negative air ions from a plant. The present disclosure also relates to a power supply device for use with the apparatus.

### BACKGROUND ART

The following discussion of the background to the disclosure is intended to facilitate an understanding of the present disclosure only. It should be appreciated that the discussion is not an acknowledgement or admission that any of the material referred to was published, known or part of the common general knowledge of the person skilled in the art in any jurisdiction as at the priority date of the disclosure.

Negative Air Ions (NAIs) may effectively accelerate the precipitation of particular matters in the surrounding environment and improves the indoor air quality. They may also keep airborne allergens and germs at bay, and may neutralize positive ions generated by electronic appliances. It is shown that NAIs may provide an overall calming effect, relieve stress and drowsiness, boost energy and improve alertness, and bring about other health benefits to human beings.

Existing NAIs generating systems include purely electrical NAIs generators, as well as plant-based NAIs generator where power pulses are used to stimulate plants for producing negative air ions. Plant-based NAIs generators, which are more beneficial to human health, may not achieve a satisfactory NAIs generation efficiency and air cleaning capability. In addition, plant-based NAIs generators which uses high-voltage power pulses may bring up safety concerns to a user or to a person coming close to the system.

The present disclosure contemplates that it would be desirous to provide an apparatus capable of producing NAIs from a plant to at least alleviate or mitigate the afore-mentioned problems.

### SUMMARY

In accordance to one aspect of the present disclosure, there is an apparatus for producing negative air ions from a plant, comprising: —a power supply module; a voltage pulse module connectable to the power supply module, the power supply module being configured to provide a pre-determined input voltage VIN to the voltage pulse module for generating a negative voltage pulse, and to adjust a reflected voltage pulse from the voltage pulse module; and a stimulating probe connected to the voltage pulse module and configured to transmit the negative voltage pulse to a root portion of the plant.

In some embodiments, the power supply module comprises a transformer with a primary side and a secondary side, and a voltage stabilizing circuit connected to both the primary side and the secondary side so as to bridge an isolation gap of the transformer.

In some embodiments, the voltage stabilizing circuit comprises one or more bleed resistors of a pre-determined resistance value.

In some embodiments, a lower limit of the resistance value of the one or more bleed resistors is determined based on a perceptible threshold of leakage current strength, and an upper limit of the resistance value of the one or more bleed resistors is determined based on an operational condition of the transformer.

In some embodiments, the voltage stabilizing circuit further comprises a circuit protection device.

In some embodiments, the power supply module comprises a power outlet interface for connecting to a power cable configured to transmit the input voltage V_{IN} to the voltage pulse module. In some embodiments, the power outlet interface is a USB receptacle configured to receive a USB connector of the power cable.

In some embodiments, the power supply module comprises a power inlet interface configured to connect to a two-pin power socket, and/or a three-pin power socket. In some embodiments, a reference line at the secondary side of the transformer is connected to an earth grounding pin of the three-pin power socket.

In some embodiments, the apparatus further comprises a proximity sensing module configured to detect an intruding subject in the vicinity of the plant.

In some embodiments, the proximity sensing module comprises one or more of the following proximity sensors: active infrared proximity sensor, passive infrared proximity sensor, radio frequency proximity sensor, laser proximity sensor, time-of-flight (ToF) proximity sensor, inductive proximity sensor, capacitive proximity sensor.

In some embodiments, the apparatus further comprises a touch sensing module configured to detect a subject coming in contact with the plant.

In some embodiments, the apparatus further comprises a controller configured to control operation of the apparatus based on data from the proximity sensing module and/or from the touch sensing module.

In some embodiments, the apparatus comprises a housing configured to contain at least the voltage pulse module and to receive a plant pot. In some embodiments, the first surface comprises a concave portion sized and shaped to receive a bottom part of the plant pot.

In some embodiments, the apparatus comprises at least two proximity sensors mounted on a peripheral edge of the housing in a symmetrical manner for forming a proximity sensing zone.

In some embodiments, the voltage pulse module is configured to attach to a side wall of a plant pot.

In some embodiments, the voltage pulse generation module is shaped and dimensioned to fit in a cavity on the plant pot.

In some embodiments, the voltage pulse generation module comprises a clip for attaching to the side wall of the plant pot. In some embodiments, one clip arm of the clip is configured to transmit the negative voltage pulse to the root portion of the plant.

In some embodiments, the apparatus is configured to connect to a power source mounted on a ceiling surface, and a plurality of sling cables are configured to hold a plant pot in a suspended position, wherein at least one of the plurality of sling cables is configured to transmit the predetermined input voltage V_{IN} from the power supply module to the voltage pulse module.

In some embodiments, the apparatus is configured to connect to a power source mounted on a ceiling surface, and a plurality of sling cables are configured to hold a plant pot in a suspended position, wherein at least one of the plurality of sling cables is configured to transmit the negative voltage pulse from the voltage pulse module to the stimulating probe.

In some embodiments, the pre-determined input voltage V_{IN} is between 3.3V and 100V.

In some embodiments, a voltage level of the negative voltage pulse is between −2 kV and −48 kV.

In accordance to another aspect of the present disclosure, there is a power supply device for use with an apparatus for producing negative air ions from a plant. The power supply device comprises: —a transformer with a primary side and a secondary side, and a voltage stabilizing circuit connected to the primary and secondary sides so as to bridge an isolation gap of the transformer, wherein the voltage stabilizing circuit is configured to adjust a reflected voltage pulse from a voltage pulse module of the apparatus.

In some embodiments, the voltage stabilizing circuit comprises one or more bleed resistors of a pre-determined resistance value.

In some embodiments, a lower limit of the resistance value of the one or more bleed resistors is determined based on a perceptible threshold of leakage current strength, and an upper limit of the resistance value of the one or more bleed resistors is determined based on an operational condition of the transformer.

In some embodiments, the voltage stabilizing circuit further comprises a circuit protection device.

In some embodiments, the power supply device further comprises one or more of the following: an input rectifying and filtering circuit at the primary side, an output rectifying and filtering circuit at the secondary side.

In some embodiments, the power supply device further comprises a power outlet interface for connecting to a power cable configured to transmit the input voltage V_{IN} to the voltage pulse module. In some embodiments, the power outlet interface is a USB receptacle configured to receive a USB connector of the power cable.

In some embodiments, the power supply device further comprises a power inlet interface for connecting to a two-pin power socket, and/or a three-pin power socket.

In some embodiments, a reference line at the secondary side of the transformer is connected to an earth grounding pin of the three-pin power socket.

In some embodiments, the power supply device is configured to derive a pre-determined input voltage V_{IN} of between 3.3V and 100V for the voltage pulse module.

Other aspects of the disclosure will be apparent to those of ordinary skill in the art upon review of the following description of specific embodiments of the disclosure in conjunction with the accompanying drawings.

### BRIEF DESCRIPTION OF THE DRAWINGS

Various embodiments are described, by way of example only, with reference to the accompanying drawings, in which:

FIG. 1 is a block diagram of an apparatus for producing negative air ions from a plant according to various embodiments;

FIG. 2 illustrates a circuit diagram of a power supply module/device of the apparatus according to one embodiment;

FIGS. 3A and 3B illustrate circuit diagrams of a power supply module/device of the apparatus according to further embodiments;

FIG. 4 is a perspective view of an apparatus for producing negative air ions according to some embodiments;

FIGS. 5A and 5B are side views of the apparatus of FIG. 4 illustrating the placement of a stimulating probe;

FIGS. 6 to 8 are sectional views of the apparatus of FIG. 4;

FIG. 9 is a perspective view of an apparatus for producing negative air ions according to some embodiments;

FIGS. 10 to 12 illustrate a voltage pulse module of the apparatus of FIG. 9;

FIG. 13 illustrates an apparatus for producing negative air ions according to another embodiment;

FIGS. 14 and 15 illustrate an apparatus for producing negative air ions according to two other embodiments;

FIG. 16 illustrates the amount of negative air ions emission measured for the apparatus of the present disclosure and for other plant-based NAIs generating systems using an ungrounded power supply;

FIG. 17 illustrates the amount of negative air ions emission measured for the apparatus of the present disclosure and for other electronic air ionizers;

FIGS. 18A and 18B illustrate a test designed for measuring the air cleaning capability of the apparatus, and measurement data showing reduction of PM2.5 concentration over time by using the apparatus;

FIG. 19 illustrates use of the apparatus in a cloud-connected system;

FIGS. 20A and 20B illustrate a block diagram of a second embodiment of the invention;

FIGS. 21A and 21B contrast negative ion release for a 5 volt input for a universal adapter, a grounded plug, and a non-grounded plug; and

FIGS. 22A and 22B contrast negative ion release for a 12 volt input for a universal adapter, a grounded plug, and a non-grounded plug.

### DETAILED DESCRIPTION

Throughout this specification, unless otherwise indicated to the contrary, the terms ‘comprising’, ‘consisting of’, ‘having’ and the like, are to be construed as non-exhaustive, or in other words, as meaning ‘including, but not limited to’.

Throughout the specification, unless the context requires otherwise, the word ‘include’ or variations such as ‘includes’ or ‘including’ will be understood to imply the inclusion of a stated integer or group of integers but not the exclusion of any other integer or group of integers.

Throughout the specification, certain embodiments may be disclosed in a range format. It should be understood that the description in range format is merely for convenience and brevity and should not be construed as a limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. Ranges are not limited to integers, and can include decimal measurements. This applies regardless of the breadth of the range.

Unless defined otherwise, all other technical and scientific terms used herein have the same meaning as is commonly understood by a skilled person to which the subject matter herein belongs.

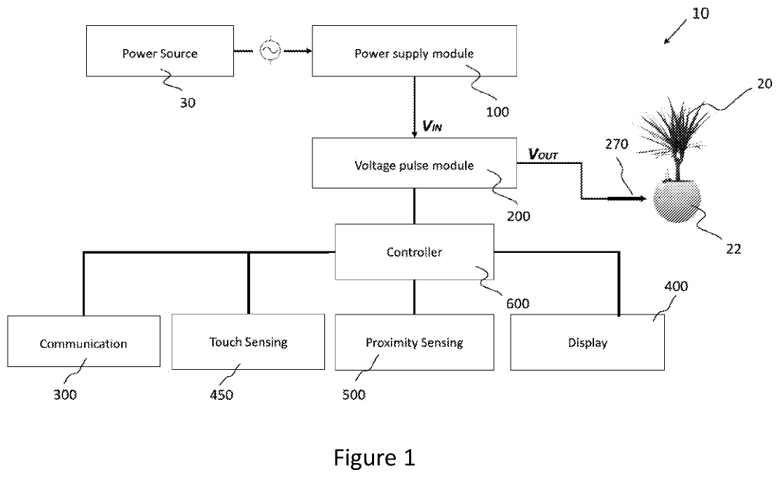

In accordance to various embodiments of the invention and with reference to FIGS. 1 to 3B, there is an apparatus 10 for producing negative air ions from a plant 20. The apparatus comprises a power supply module 100, a voltage pulse module 200 connectable to the power supply module 100, the power supply module 100 being configured to provide a pre-determined input voltage V_{IN} to the voltage pulse module 200 for generating a negative voltage pulse, and to adjust a reflected voltage pulse from the voltage pulse module 200. The apparatus 10 further comprises a stimulating probe 270 connectable to the voltage pulse module and configured to transmit the negative voltage pulse to a root portion of the plant. The negative voltage pulse stimulates the plant 20 to produce negative air ions, which may lead to reduction of particulate pollutants in the surrounding air.

In various embodiments, the power supply module 100 may operate to derive a required electrical power from the power source 30. The power supply module 100 may be in the form of an external power supply device 100, for example an external power adapter, which may be connected to the voltage pulse module 200 to provide the pre-determined input voltage V_{IN} to the voltage pulse module 200 via a power cable or a power cord. Alternatively, the power supply module 100 and the voltage pulse module 200 may both be configured as internal components of the apparatus 10, wherein the power supply module 100 is a built-in or internal supply which derives the required voltage from the power source 30 as the input voltage for the voltage pulse module 200. It is to be appreciated that similar circuitry arrangement may be used for both the external power supply device 100 and the built-in/internal power supply module 100.

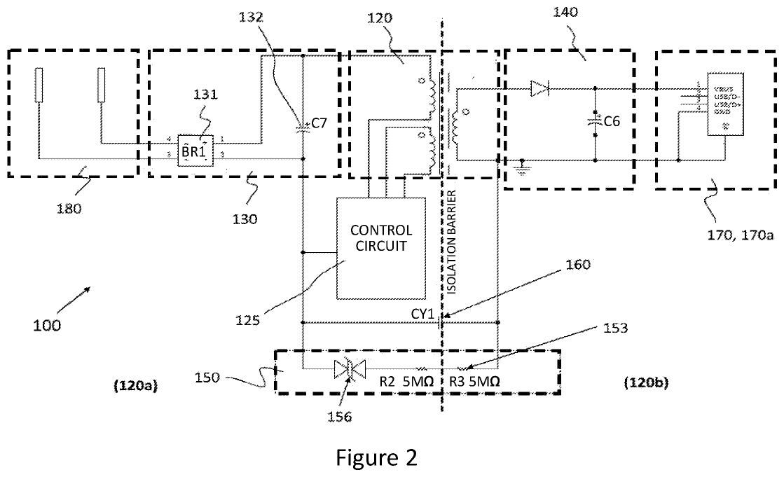

As shown in the non-limiting example of FIG. 2, the power supply module 100 comprises a transformer 120 with a primary side 120-a and a secondary side 120-b. The power supply module 100 further comprises an input rectifying and filtering circuit 130 at the primary side 120-a, an output rectifying and filtering circuit 140 at the secondary side 120-b, and a control circuit 125 configured to control operation of the transformer 120. The voltage stabilizing circuit 150 is configured to connect to the primary and secondary side 120-a, 120-b at two ends.

In various embodiments, the power supply module 100 is provided with a power inlet interface 180 for connecting to a two-pin or two-prong power socket at the primary side 120-a of the transformer 120. It is to be appreciated that the power supply module 100 may be connected directly to an electric mains socket or may be connected to a power socket that is connected to the electric mains socket via the power inlet interface 180 when in use.

In various embodiments, the power supply module 100 may receive an alternating current (AC) voltage from the power source 30, for example from the electric mains, and converts the AC voltage into a direct current (DC) voltage of a pre-determined voltage level. It is to be appreciated that the circuitry design of the power supply module 100 may be adapted to work with different power sources 30, including mains electricity power used in different countries which are provided at different voltage levels and/or at different alternating frequencies.

In various embodiments, the input rectifying and filtering circuit 130 may comprise a bridge rectifier 131 and a capacitor 132 connected in parallel. The incoming AC voltage from the power source 30 may be rectified at the bridge rectifier 131 and may undergo filtration at the capacitor 132 to produce a DC voltage (e.g. a high DC voltage) suitable for driving the control circuit 125 and the transformer 120.

In various embodiments, the power supply module 100 may be a switch mode power supply (SMPS), wherein the control circuit 120 may drive the transformer 120 at a high switching frequency for outputting a direct current signal at a desired voltage level. The transformer 120 may be a step-down transformer which converts the high DC voltage to a DC voltage of an appropriate and relatively lower voltage level. As may be appreciated by a skilled person, the transformed level (the stepped down voltage generated on the secondary side 120-b of the transformer 120) is set in terms of a winding ratio between the primary and secondary sides 120-a, 120-b of the transformer 120.

The “stepped-down” DC voltage may be further rectified and filtered at the output rectifying and filtering circuit 140 to achieve a constant DC voltage. In other words, the waveform of the “stepped-down” DC voltage is smoothed by the output rectifying and filtering circuit 140 with minimal or insignificant residual ripple variations. The voltage level of the constant DC voltage is generated according to the required voltage level for the voltage pulse module 200 to operate. The constant DC voltage that the power supply module 100 derives from the incoming electric power is the input voltage V_{IN} of the voltage pulse module 200.

It is appreciated that other types of power supply circuits that are operable to derive the required DC voltage from the power source 30 may be used in the power supply module 100 of the apparatus 10. For example, instead of a SMPS circuit, the power supply module 100 may operate on a linear power supply circuit, which may comprise a transformer for converting the incoming electric power (e.g. mains electricity power) to an AC voltage of a lower voltage level from which a desired DC voltage can be derived. For example, the lower AC voltage may be converted to a pulsating DC voltage using a rectifier and subsequently smoothed into a constant DC voltage using a filter. Further, the power supply module 100 may also operate on a variable voltage power supply circuit using a voltage regulator to produce an adjustable voltage power output.

In various embodiments, the voltage stabilizing circuit 150 is configured to connect to the primary and secondary sides 120-a, 120-b of the transformer 120. Accordingly, isolation gap of the transformer 120 is bridged by the voltage-stabilizing circuit 150, and an electric current is allowed to flow from the secondary side 120-a to the primary side 120-b across the transformer core and vice versa. The voltage-stabilizing circuit 150 provides for any undesirable electrical field to be discharged to the primary side 120-a, and/or otherwise compensated by the power input from the primary side 120-b. The impact of such undesirable electrical field on the operation of the power supply module 100 is thus minimized/eliminated.

In some embodiments, the power supply module 100 may further comprise a bypass/decoupling capacitor 160 for electromagnetic compatibility (EMC) noise control, and the voltage stabilizing circuit 150 may be connected in parallel with the bypass/decoupling capacitor 160.

As can be seen in FIG. 2, the voltage stabilizing circuit 150 may comprise a resistor 153. Alternatively, the voltage stabilizing circuit 150 may comprise more than one resistors 153 connected in series, so as to provide a desirable resistance value of the voltage stabilizing circuit 150. The resistor 153 may also be referred to as a bleed resistor 153.

The one or more resistors 153 can effectively minimize variations in the electrical power (i.e. the input voltage V_{IN}) that is transmitted to the voltage pulse module 200 from the power supply module 100.

In use, as the load (including the plant pot 22 and the voltage pulse module 200) is not readily connected to an earth ground and is therefore floating, the negative voltage pulse transmitted to the plant 20 will also produce an opposite pulse back on to the power supply module 100. This reflected voltage pulse is both wasted energy and destructive to the components of the power supply module 100. The one or more resistors 153 may minimize the impact of the reflected voltage pulse on to the power supply module 100. More specifically, the one or more resistors may clamp or suppress the reflected voltage pulse to a substantially low voltage level, such that the impact of the reflected voltage pulse on the operation of the power supply module 100 is eliminated or minimized, and the same or substantially the same amount of electrical power that is derived by the power supply module 100 may be transmitted as the input voltage V_{IN} to the voltage pulse module 200 without being affected or comprised by the reflected voltage pulse.

In a test conducted to observe the effect of the reflected voltage pulse on the efficiency of the system, two types of power supply, i.e. the power supply module 100 and a battery pack (i.e. a direct DC voltage supply without any earth ground connection), are used to provide a DC voltage of 9V and 12V to the voltage pulse module 100 for generating a negative voltage pulse (i.e. an output voltage V_{OUT}). When the power supply module 100 is used, the output voltage V_{OUT} of the voltage pulse module 200 is measured at about −5.6 KV to −6.2 KV and at about −7 KV to −7.5 KV respectively. In contrast, when the ungrounded battery pack is used as the power supply, the output voltage V_{OUT} of the voltage pulse module 200 is measured at a substantially lower voltage level of about −1.9 KV to −2.4 KV and −2.2 KV to −3.4 KV respectively. This is because, part of the electrical power from the battery pack is diminished or wasted due to the voltage pulse reflected from the voltage pulse module 200 on to the battery pack, and the actual voltage received at the voltage pulse module 200 is not 9V and 12V as intended when such battery packs are used as the power supply.

This impact of the reflected voltage pulse is minimized by using the power supply module 100 which is shown to be capable of providing a desired and stable voltage to the voltage pulse module 200 by adjusting, clamping and suppressing the reflected voltage pulse. Advantageously, this allows the voltage pulse module 200 to generate a negative voltage pulse at an intended voltage level. As such, the apparatus 10 may produce negative air ions in an efficient manner.

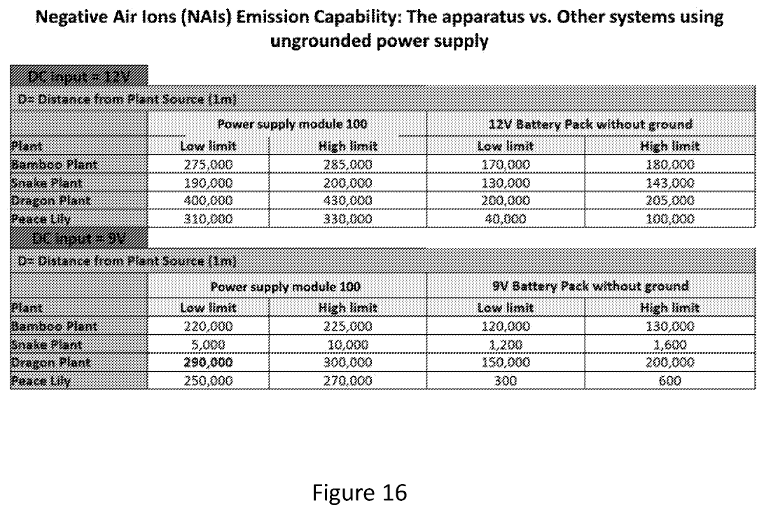

The effect of the reflected voltage pulse on the system efficiency is further illustrated in FIG. 16, which shows the differences in the negative air emission amount for systems using the afore-mentioned two types of power supply. As can be seen from FIG. 16, systems using the power supply module 100 is capable of a producing a higher amount of negative air ions, as compared to the systems using the ungrounded battery pack as the power supply. This observation is consistent for different plant types.

In various embodiments, the voltage stabilizing circuit 150 comprising the one or more resistors 153 may have a pre-determined resistance value, or a resistance value within a pre-determined range.

In various embodiments, a lower limit of the pre-determined resistance range or the minimum resistance value is determined primarily based on safety and regulatory requirements, particularly, based on a perceptible threshold of leakage current strength. As the isolation gap of the transformer 120 is bridged, the impedance or resistance value of the voltage stabilizing circuit 150 is critical to balance safety and effectiveness. More specifically, the one or more resistors 153 have a resistance above the minimum resistance value, such that the current that is allowed to flow through the resistor 153 is controlled below a threshold value even when a relative high voltage level is applied across the voltage stabilizing circuit 150 during the operation of the apparatus 10.

For example, the minimum resistance value of the voltage stabilizing circuit 150 may be determined based on the following requirements: i) the leakage current measured for the power supply module 100 is within safety standard limits during insulation tests; and ii) the worst case touch leakage current measured for the power supply module 100 is below the perceptible threshold, for example, below 0.1 mA in accordance to the International Electrotechnical Commission (IEC) standard.

In various embodiments, an upper limit of the pre-determined resistance range or the maximum resistance is determined primarily based on an operational condition of the transformer 120. More specifically, the resistance value of the voltage stabilizing circuit 15 is controlled below the upper limit such that the maximum voltage across the voltage stabilizing circuit 150 does not cause overstressing on the transformer 120. For example, the upper limit may be determined based on the following requirements: —i) the maximum voltage across the transformer 120 (more specifically across the isolation gap of the transformer 120) is less than 10% of the negative voltage pulse magnitude (i.e, V_{OUT}) at maximum possible pulse current of the apparatus 10; and ii) the maximum voltage across the transformer 120 is less than the rated transformer insulation strength at maximum pulse current of the apparatus 10.

In some embodiments, the one or more resistors 153 may have a resistance of 10M ohm. It is to be appreciated that other semiconductor devices of suitable impedance may also be used in the voltage stabilizing circuit 150 for bridging the isolation gap of the transformer 120.

In various embodiments, the voltage stabilizing circuit 150 of the power supply module 100 may further comprise a circuit protection device. The circuit protection device operates to limit voltage across the transformer 120 below a safety voltage level in both in normal operations and in fault conditions.

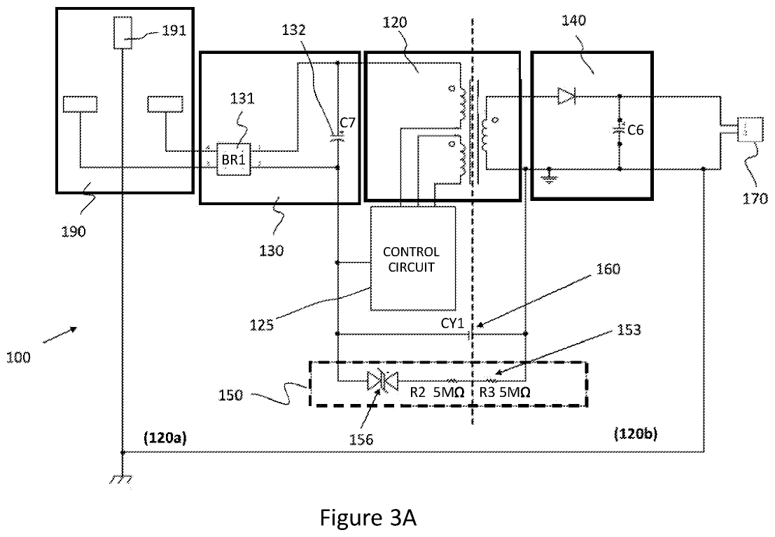

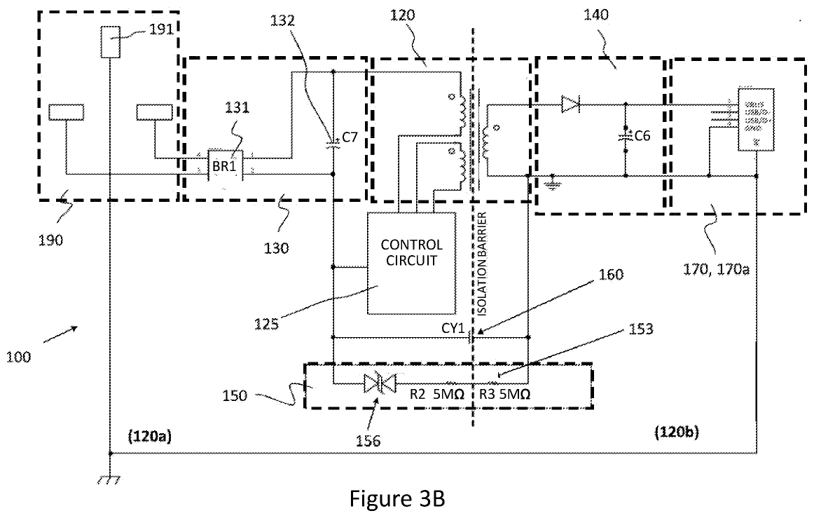

In some embodiments as shown in FIG. 2 to FIG. 3B, the circuit protection device may be a transient-voltage-suppression diode 156 (or TVS diode 156) that is connected to the resistor 153 in series. As the isolation gap of the transformer 120 is bridged by the voltage stabilizing circuit 150, a leakage current is more likely to flow from the power supply module 100, as compared with power supplies in isolation configuration. The TVS diode functions as a protection device that reduces/minimize a leakage current in the power supply module 100. The TVS diode 153 may be bi-polar or bi-directional, as shown in FIG. 2, for managing leakage current from either the primary side 120-a (i.e. power inlet) or from the secondary side 120-b (i.e. power outlet). The TVS diode 153 may also protect the circuits/components of the power supply module 100 from the damaging effects of transient voltages, for example, any power surges from the power source 30 (e.g. the mains electricity power) and a reflected voltage pulse from the voltage pulse module 100. Advantageously, the safety and robustness of the power supply module 100 is improved.

It is to be appreciated that TVS diodes with suitable operating parameters, including the reverse stand-off voltage VWM (i.e. the voltage below which no significant conduction occurs) and/or clamping voltage VC (the voltage at which the device will conduct its fully rated current), may be used to manage the leakage current in the power supply module 100. In some embodiments, the TVS diode may have a reverse stand-off voltage of 400V and a clamping voltage of 648V.

It is also to be appreciated that other circuit protection devices that may operate to limit voltage surges may be used in the power supply module 100 which include, but are not limited to Zener or Avalanche diode, gas-discharge tube (or GDT), metal oxide varistor (MOV) or silicon controlled rectifier.

With reference to FIG. 3A which illustrates the power supply module 100 in accordance with another embodiment, the power inlet interface 190 of the power supply module 100 is configured to connect to a three-pin or three-prong power socket, and a reference line at the secondary side 120-b of the transformer 120 may be connected to an earth grounding pin 191 of the power socket. The arrangement of connecting the reference line of the transformer secondary side 120-b to the earth grounding pin 191 provides for an alternative or a supplemental path for dissipating, adjusting or clamping the reflected voltage pulse from the load side (i.e. the voltage pulse module 200 and the plant pot 22), and allows a stable input voltage V_{IN} to be provided to the voltage pulse module 200.

In various embodiments, the power supply module 100 may further comprise a power outlet interface 170 at the secondary side 120-b of the transformer 120. The power outlet 170 may be provided in the form of a power cable connector 170a (such as a USB receptacle 170a as shown in FIG. 2 and FIG. 3B) for connecting to a power cable 171 to transmit the input voltage V_{IN} to the voltage pulse module 200 of the apparatus 10.

In embodiments where the power outlet interface 170 is in the form of a USB receptacle 170a, a ground pin (GND/Pin 4) and the metal chassis (PE/Pin 5) may be configured to connect to the earth grounding pin 191 of the power socket via the power inlet interface 190.

By connecting the secondary side 120-b of the transformer 120 to the earth ground, any undesired voltage pulse reflected from the load to the power supply module 100 may be effectively discharged or dissipated to the earth via the earth grounding pin 191. As such, operation of the transformer 120 is not affected by such reflected voltage pulse and a stable voltage may be produced by the power supply module 100 and transmitted to the voltage pulse module 200.

In various embodiments, the power supply module 100 may supply a pre-determined input voltage V_{IN} of 3.3V to 100V to the voltage pulse module 200. In some embodiments, the power supply module 100 may supply a pre-determined input voltage V_{IN} of 3.3V to 48V to the voltage pulse module 200. In some embodiments, the power supply module 100 may supply a pre-determined input voltage of 3.3.V to 12V to the voltage pulse module 200. In some embodiments, the power supply module 100 is configured to supply a pre-determined input voltage of 9V to the voltage pulse module 200. In some embodiments, the power supply module 100 is configured to supply a pre-determined input voltage of 12V to the voltage pulse module 200.

In various embodiments, the voltage pulse module 200 operates to generate a negative voltage pulse V_{OUT} from the input voltage V_{IN}. Any suitable voltage pulse generating circuits may be used in the voltage pulse module 200 for producing the negative voltage pulse V_{OUT} of a desired voltage level and a desired pulse frequency. For example, a medium-high voltage pulse generating circuit based on the field-effect transistor technology may be used, wherein a field effect transistor (e.g. a MOSFET switch) may be driven by a micro-controller (e.g. a single-chip microcontroller) to first output a low power modulation driving signal, which may be boosted to a higher voltage/power level (e.g. by using a boost converter) and then be rectified into the desired negative voltage pulse V_{OUT} for stimulating the plant 20.

In various embodiments, a voltage level of the negative voltage pulse is between −2 kV to −48 kV. In some embodiments, a voltage level of the negative voltage pulse is between −3.5 kV to −18 kV. In various embodiments, the voltage pulse module may be set/configured to output a negative voltage pulse V_{OUT} of different voltage levels depending on the type of the plant 20 and the pot size of the plant 20.

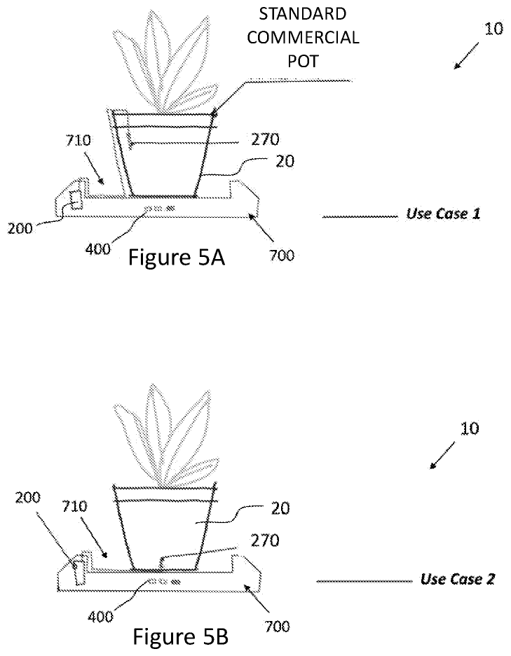

In various embodiments, the negative voltage pulse V_{OUT} is transmitted/released to a root portion of the plant 20 via a stimulating probe 270. The stimulating probe 270 is an electrode or a conductive electric terminal. The stimulating probe 270 may be configured in an elongated shape to facilitate placement/insertion to the soil. In some embodiments, the stimulating probe 270 may extend from the voltage pulse module 200 directly. In some embodiments, the stimulating probe 270 may be connected to the voltage pulse module 200 via a power cable or a power cord. As shown in FIGS. 5A and 5B, the stimulating probe 270 may be inserted into a soil contained in the plant pot 22 either from above the soil or from a bottom surface of the plant pot 22, such that it is positioned near or close to the root portion of the plant 20. The plant 20, when stimulated by the negative voltage pulse Y_{OUT} may emit more negative air ions to the surrounding environment. Air quality may be improved.

The apparatus 10 may be used with different types of plants for generating the negative air ions, including but not limited to Snake Plant (or Sansevieria trifasciata), Dragon Plant (or Dracaena marginata), Bamboo Plant (or Dracaena surculosa), Peace Lily (or Spathiphyllum), and Areca palm (or Dypsis lutescens). The apparatus 10 may also be used with plants of various sizes. In an experiment set to determine the effect of plant sources, plant size and stimulating voltage level on the production of negative air ions, it is shown that the a small size Areca palm, when stimulating with a voltage of −3.5 kV and −5.7 kV, is capable of producing negative air ions in the amount of about 232 K/cm³ and 419 K/cm³ respectively as measured at one meter from the plant source. An even higher amount of negative air ions is measured when using a bigger size Areca palm and using a higher stimulating voltage. In particular, the amount of negative air ions measured at the same distance from the plant source is increased to about 930 K/cm³ for a medium-size Areca palm stimulated with a voltage of −14 kV, and is further increased to about 1,180 K/cm³ for a medium-large size Areca palm stimulated with a voltage of −18 kV.

The same tests are conducted using other types of plants, whereby it is similarly observed that for a particular plant type (including Dragon Plant, Peace Lily, Bamboo Plant, and Snake Plant), a higher stimulating voltage level and/or a larger plant size may achieve a higher negative air emission rate of the system. Further, it is also observed that plants of different types have different negative air ion emission capabilities. Systems using small-size Dragon Plant, Peace Lily, Bamboo Plant, Snake Plant, and a stimulating voltage of −3.5 kV, are measured to produce negative air ions in the amount of about 127 K/cm³, 58 K/cm³, 31 K/cm³, 16 K/cm³ respectively at a one meter distance from the plant source. Systems using the same group of plants and a higher stimulating voltage of −5.7 kV, are measured to produce negative air ions in relatively higher amount, i.e. about 355 K/cm³, 248 K/cm³, 142 K/cm³, 261 K/cm³ respectively at a one meter distance from the plant source.

Accordingly, plant pots of different sizes are selected and used for cultivating the plant 20, and suitable stimulating voltage levels may be used for plant sources of different types and of different sizes to achieve a desirable negative air emission rate of the system. For plants that have a relative high negative air ions emission capability (e.g. Areca palm, Dragon plant), a desired negative air ion emission rate may be achieve by applying a negative voltage pulse of a relatively low voltage level. For plants that have a relative slow negative air ions emission capability (e.g. Bamboo plant, Snake plant, Peace Lily) to achieve the same performance, a voltage pulse of a relatively higher voltage level may be required.

The apparatus 10 may be used with plants cultivated in commercial plant pots, many of which may be made of ceramic or plastic materials, and are ungrounded. The power supply module 100 of the apparatus 10 with the voltage stabilizing circuit 150 provides the benefits of reducing/minimizing the effect of the reflected voltage pulse” on the system. Particularly, the power supply module 100 could operate to deliver a stable and steady input voltage V_{IN} to the voltage pulse module 200 as intended, because the reflected voltage pulse may be adjusted or clamped to a substantially low voltage level, via the voltage stabilizing circuit 150.

In embodiments where power supply module 100 is configured to connect to a three-pin power socket as shown in FIG. 3, the connection of the secondary side 120b to the earth grounding pin 191 provides a voltage dissipation path as an alternative or supplemental means for adjusting and clamping the reflected voltage pulse. Efficiency of the power supply module 100 is achieved. In addition, resistance value of bleed resistors 153 of the voltage stabilizing circuit 150 is within a particular range, so as to control a leakage current that may result from the closing of the isolation gap of the transformer 120 below an imperceptible level and to control the voltage across the transformer 120 below the operational threshold of the transformer 120. In some embodiments wherein a circuit protection device (e.g. the bipolar TVS diode) is connected to the bleed resistors 153, residual leakage current which may cause mild discomfort to a user is further reduced.

Despite the absence of the earth ground connection for the plant pot 22 and the voltage pulse module 200, the apparatus 10 could still demonstrate stability of voltage pulse generation and stability of negative air ions (NAIs) emission. Also, product safety and reliability of the apparatus 10 is achieved.

When the apparatus 10 is operation to provide stimulating voltage pulse to the plant 10, a person coming in contact with the plant 20 (e.g. leaf portion of the plant) may experience uncomfortable sensation. This is due to the mild electric shock caused by an electrical power stored in the system. The electrical power comes primarily from the capacitance of the plant pot system, i.e. the plant 22, the plant 20 and the soil cultivating the plant 20. The capacitance of the plant pot system is determined by the geometry of the system, including size and shape of the plant 20, which may be difficult to control.

In various embodiments, the apparatus 10 may be provided with one or more levels of protection for preventing a person including a user from getting electrical shock from the plant 20 which carries electrical charges.

In various embodiments, the apparatus 10 may comprise a proximity sensing module 500. The proximity sensing module 500 comprises one or more proximity sensors 510 configured to detect an intruding subject in the vicinity of the plant 20, and a controller 600 configured to control operation of the apparatus 10 based on a sensor data from the one or more proximity sensors 500. The proximity sensing module 500 provides for a safety measure to prevent a user from getting electric shocks by the electrical pulses, for example, by generating a sound alarm to the user approaching an apparatus that is in operation.

The one or more proximity sensors 600 may comprise one or more of the following: an ultrasonic proximity sensor, an active infrared (IR) proximity sensor, a passive infrared (IR) proximity sensor, a radio frequency (RF) proximity sensor, a laser proximity sensor, a time-of-flight (ToF) proximity sensor, inductive proximity sensor, and capacitive proximity sensor. It is to be appreciated that proximity sensors 510 operating on different proximity sensing technologies depending on the system requirements. The one or more proximity sensors 510 may create a “fencing zone” around the plant 20 within which the presence of an intruding object (including a person such as a user of the apparatus) may be detected. The sensor data is then transmitted to the controller 600.

In various embodiments, the apparatus 10 may comprise a touch sensing module 450 for detecting a subject (e.g. a person) coming in contact with the plant. The touch sensing module 450 may comprise one or more voltage and current sensing devices configured to detect a change in voltage and current in the system when a person touches the plant 20 or when a person is about to touch the plant 20. The one or more voltage and current sensing devices may be provided with integrated or external short circuit and overload detection.

As a person comes in contact with the plant 20, the stored electrical power may be dissipated through the body of the person, which leads to a change in the voltage/current change as may be detected by the touch sensing module 450. Further, the touch sensing module 450 may be configured to detect level of leakage and/or influence on the electric field as the person comes sufficiently close to the plant, e.g. when the finger of the person comes near the plant leaf. The apparatus 10 may be controlled to lower the voltage level just before or at the instant of contact, which essentially provide an alternative pathway to dissipate the stored energy than the body of the person and reduce the strength of sensation to an imperceptible level. Alternatively, the apparatus 10 may be controlled to stop generating the negative voltage pulse (i.e. stop putting energy into the plant pot system) as the contact approaches, thereby allowing naturally or artificially enhanced leakage to lower the voltage level and to reduce the strength of sensation. In various embodiments, the controller 600 may include suitable hardware components such as a microcontroller unit (MCU), microprocessors, coprocessors, digital signal processors (DSP), or control circuits implemented in the form of integrated circuits (IC) chips (e.g. an Application Specific Integrated Circuit or ASIC). The controller 600 operates to process sensor data and may integrate sensor data for further processing.

The controller 600 controls operation of the apparatus 10 based on the data from the touch sensing module 450 and/or the proximity sensing module 500. For example, the controller 600 may be configured to deactivate the voltage pulse module 200 or the power supply module 100 when: —(a) once the one or more proximity sensors 510 detect an intruding object or person within the fencing zone; and (b) once the touch sensing module 450 detects that the person touches or is about to touch the plant 20. The apparatus 10 stops applying voltage pulses to the plant 20. Alternatively or additionally, a sound alarm may be triggered based on data from the touch sensing module 450 and from the proximity sensing module 500.

Particularly, the proximity sensing module 500 provides for a first level of protection for an intruding person coming close to the plant 20, and the touch sensing module 450 provides another level of protection for a person that touches/is about to touch the plant 20. At the same time, operation of the apparatus 10 may be controlled based on the proximity sensing data and/or the touch sensing data. As the person is no longer in contact with the plant 20 and moves away from the plant and out of the fencing zone, as may be detected by the touch sensing module 450 and the proximity sensors 510, the controller 600 may activate the apparatus 10 to continue stimulating the plant 20. A safe and efficient system can then be achieved.

In some embodiments, the apparatus 10 may further comprise a communication module 300 for receiving and transmitting information from an external user device. It is appreciated that the data communication may be achieved using different communication protocols including, but not limited to 4G, Wi-Fi™, and Bluetooth™ wireless branded communication protocols. Information regarding the apparatus 10 including operational state, operational history of the apparatus 10 may be transmitted to the external user device for displaying to a user. The user may also enter commands from the external device to control the operation of the apparatus 10 from a distance.

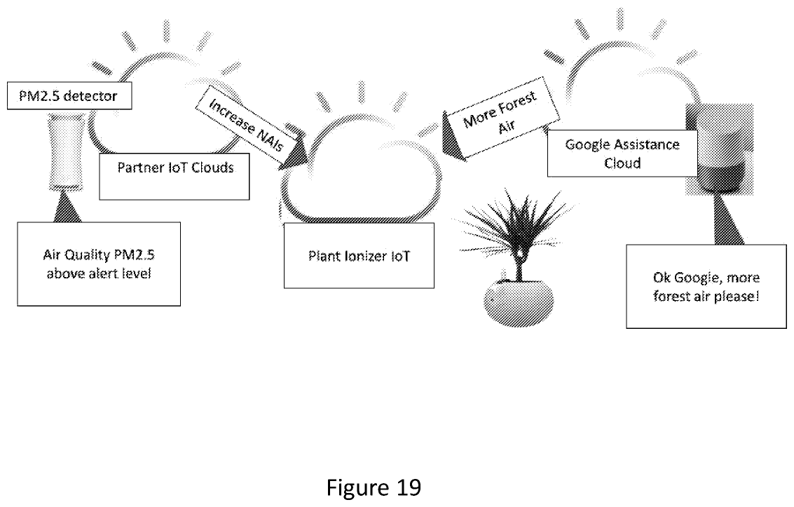

In some embodiments, the communication module 300 may be configured to connect to a network interface through which data communication/internet connectivity with other network-connected devices (e.g. one or more external user devices, one or more other apparatus 10 placed at different locations, a PM2.5 sensing device for collecting air quality data in the surrounding environment) may be established. Direct connectivity among the various devices are not required, thus remotely monitoring and control of the apparatus 10 may be achieved. In some embodiments as illustrated in FIG. 19, the network may be implemented on a backend cloud server. The various cloud-connected devices including the apparatus 10 may interact and cooperate with each other in the cloud computing environment to form an Internet-of-Things (IoT) cloud system.

The apparatus 10 may further include other functional modules as may be conceived by a skilled person. For example, the apparatus 10 may comprise a display module 400 (e.g. a display screen, one or more LED light indicators) for displaying information about the apparatus 10 to a user, a control panel for controlling the operation of the apparatus 10, an audio unit (e.g. a speaker or buzzer) for communicating an audio message to the user (e.g. an audio alarm in case of device mal-function, upon detection of an intruding person, and etc.).

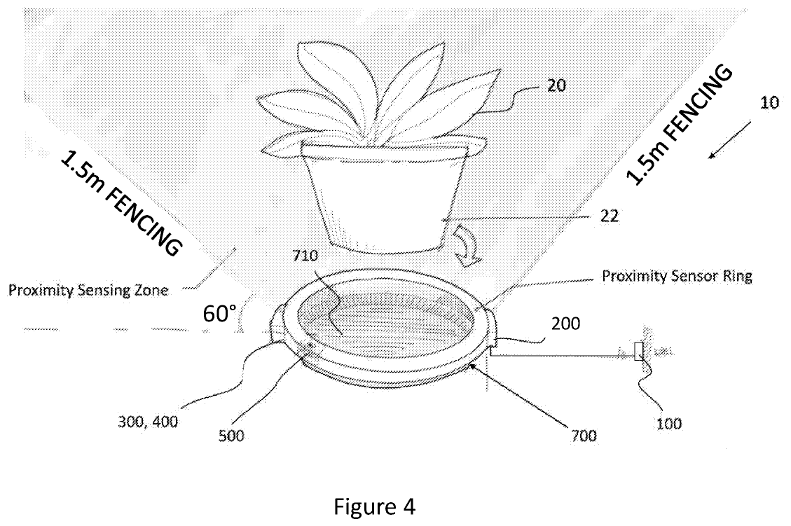

The above described components of the apparatus 10 may be arranged in different configurations. Non-limiting examples of the apparatus 10 with different configurations are illustrated in FIGS. 4 to 15.

In some embodiments and with reference to FIGS. 4 to 8, the apparatus 10 comprises a housing 700 configured to contain at least the voltage pulse generation module 200 and to receive a plant pot 22 on a first surface 710. The housing 700 may be of plate-like shape. The first surface 710 may be a planar surface above which the plant pot 22 may be placed. As illustrated in FIGS. 4 and 5, the first surface 710 may further comprise a concave portion sized and shaped to receive a bottom part of the plant pot 22. It is appreciated that the size and shape of the concave portion may substantially correspond to the size and shape of the plant pot 22 to be placed therein, and at the same time may allow a space/gap between the plant pot 22 and the side wall of the concave portion.

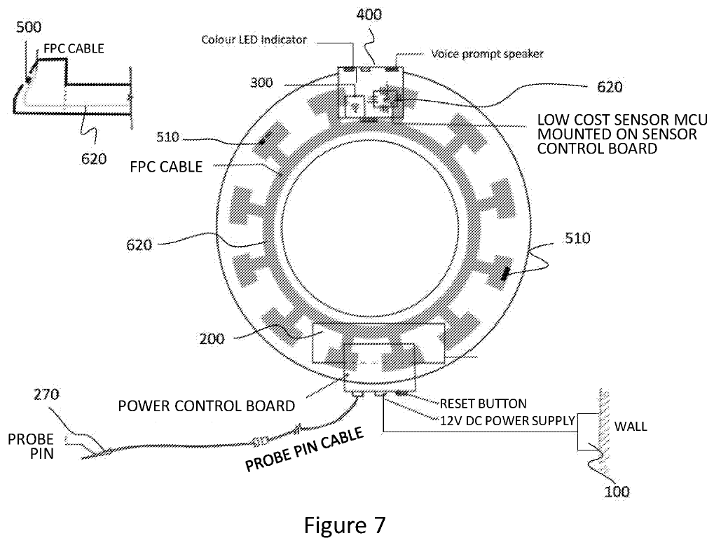

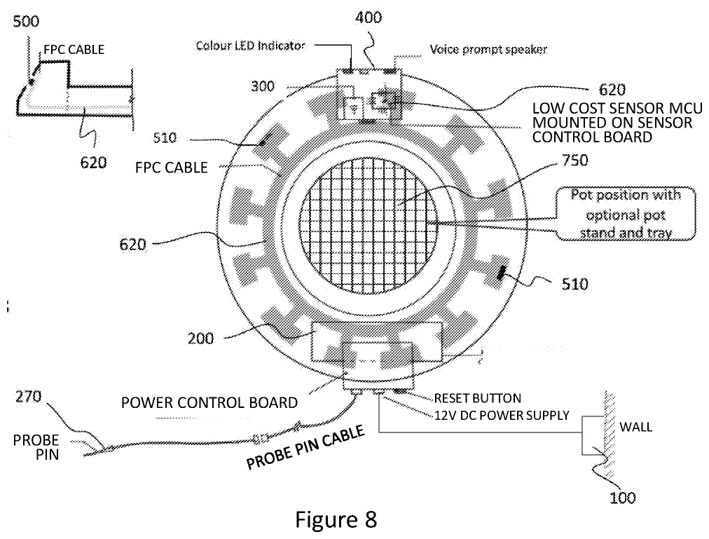

The concave portion may be a dented area on the first surface 710 of the housing 700 (i.e. a tray-like configuration as shown in FIGS. 4 to 6). Alternatively, the housing 700 may comprise a hollow part therein for receiving the plant pot 22 (i.e. a ring-like configuration as shown in FIGS. 7 and 8).

Other modules and components of the apparatus 10, including the voltage pulse module 200, the proximity sensing module 500, the communication module 300, the display module 400, may be disposed at different parts of the housing 700. The power supply module 100 may be configured as an external power supply connected to the voltage pulse module 200 via a power cable. The stimulating probe 270 extends from the voltage pulse module 200 and may be inserted into the soil in the plant pot 22 when in use.

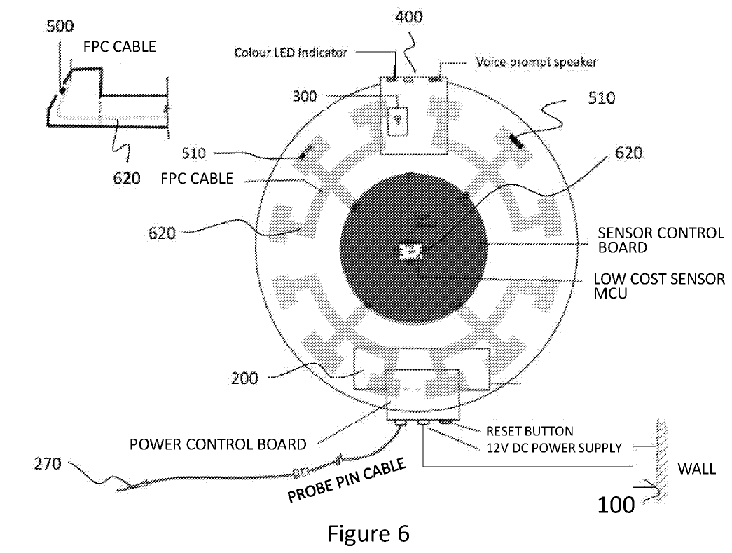

With reference to FIG. 4 and FIG. 6, the apparatus 10 may comprise at least two proximity sensors 510 mounted on a peripheral edge of the tray-like housing 700 and arranged in a symmetrical manner. The controller 600 (e.g. in form of a sensor control board with a sensor MCU) may be disposed at the concave portion/dented area of the tray-like housing 700. The controller 600 is configured to connect with each proximity sensor 510, for example, via Flexible Flat Cable (FFC) circuit 620. The communication module 300 and display module 400 may be disposed at a side portion of the housing 700. The voltage pulse module 200 at an opposite side of the housing 700, where the stimulating probe 270 is extended from and the power supply module 100 is connected to.

The symmetrical arrangement of the proximity sensors 510 allows a proximity sensing zone centered on the housing 700 (or the plant pot placed therein) to be formed. As can be seen in FIG. 4, an intruding object/person that approaches the plant 20 from any direction may be detected once entering the proximity sensing zone. Further, as the proximity sensor 510 has a sensing range limit, mounting of the proximity sensors 510 on the outermost edge of the housing 500 allows the area of the proximity sensing zone to be maximized.

With reference to FIG. 7 showing an embodiment of the apparatus 10 wherein the housing 700 is in a ring-like shape, the at least two proximity sensors 510 are similarly mounted on a peripheral edge of the housing 700 and arranged in a symmetrical manner. The controller 600 may be disposed on a side portion of the housing 700 where the communication module 300 and the display module 400 are also placed at. The FFC circuit 620 may be adapted such that the controller 600 is connected with each proximity sensor 510.

With reference to FIG. 8 showing another embodiment of the apparatus 10 wherein the housing 700 has a ring-like shape, a pot stand may be provided at the central hollow portion for supporting the plant pot 22 and/or for containing excess irrigation water from the plant pot 22.

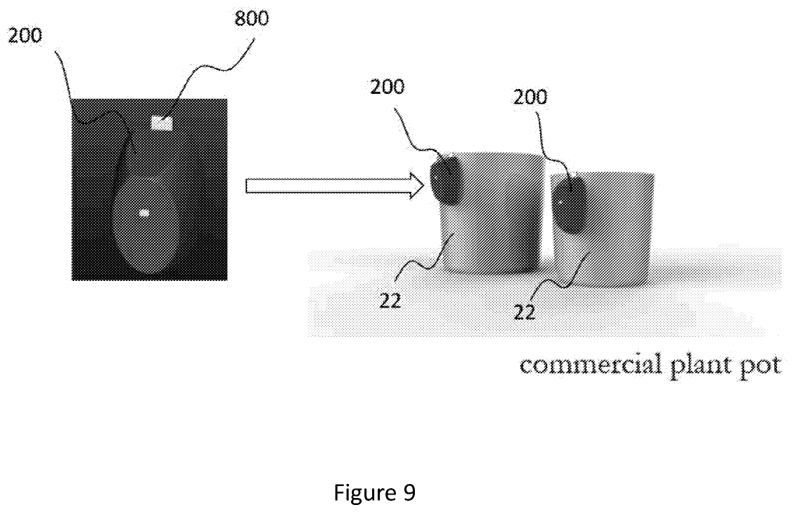

In some embodiments and with reference to FIGS. 9 to 14, the voltage pulse generation module 200 may be configured to attach to a side wall of a plant pot 22.

With reference to FIGS. 9 to 12, the voltage pulse generation module 200 may comprise a clip 800 for attaching to the side wall of the plant pot 22. The voltage pulse generation module 200 (e.g. integrated on a PCB board) may be enclosed in a casing 830. The clip 800 may be affixed or attached to the casing 830 of the voltage pulse generation module 200. The voltage pulse module 200 is connectable to the power supply module 100, for example, via a USB power cable 171 with a USB connector 176.

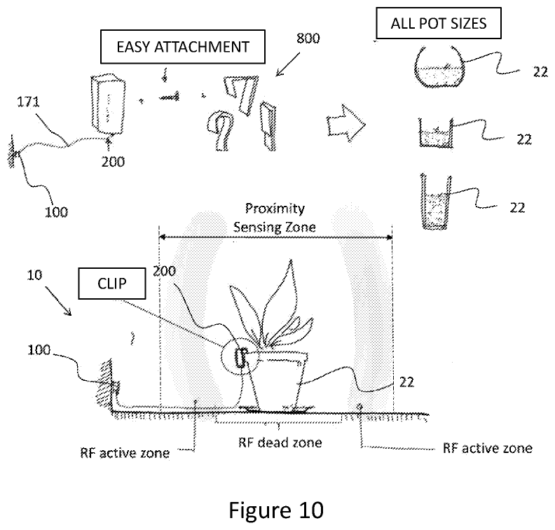

In some embodiments as illustrated in FIG. 10, the clip 800 may be removably affixed on the casing 830 of the pulse generation module 200 by an attachment means (for example, by using a screw or rivet). For plant pots with different pot rim thickness and profile, a clip 800 of a suitable size and shape may be selected and used for attaching to the plant pot. Advantageously, the voltage pulse generation module 200 may be used with commercial plant pots of different sizes and shapes.

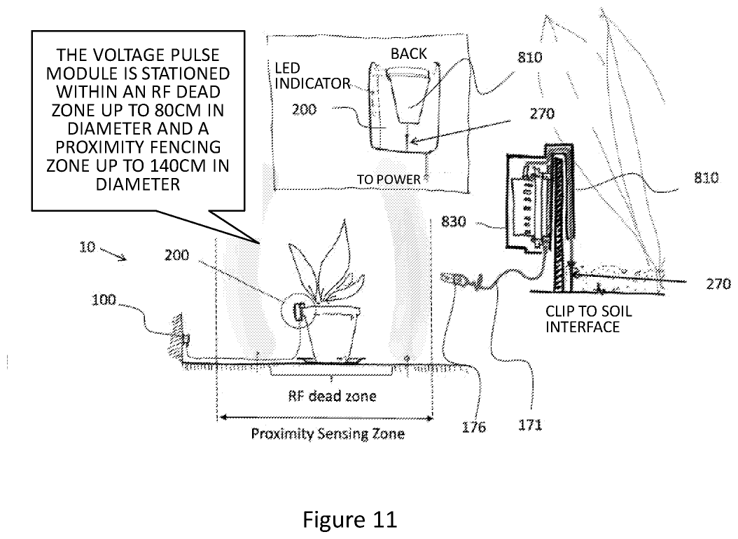

In some embodiments as illustrated in FIG. 11, the clip 800 and the casing 830 may be integrally formed as one-piece element. For example, the casing 830 and the clip 800 may be integrally moulded from a plastic material into the desired form and shape. The clip arm 810 comprises a channel or a cavity for accommodating and guiding an electric wire or a power cable that extends from the voltage pulse module 200 to the stimulating probe 270. In use, the stimulating probe 270 may be inserted into the soil for stimulating the plant.

The apparatus 10 may comprise a proximity sensing module 500 with a radio-frequency (RF) proximity sensor. The RF proximity sensor is a small-size sensor which may detect a change in the electromagnetic properties within its RF active zone. For example, an object moving through the RF active zone, or the presence of a different material therein can cause such a change.

The proximity sensing zone formed by an RF proximity sensor As can be seen in FIG. 11, the RF proximity sensor of the apparatus 10 attached to the plant pot 22 may form a proximity sensing zone around the plant pot 22 and in an approximate torus shape with sides of a similar diameter to the RF sensor (more specifically, to the antenna coil of the RF sensor). Depending on the type of RF proximity sensor used, the proximity sensing zone formed may have a diameter ranging from 50 cm to 140 cm.

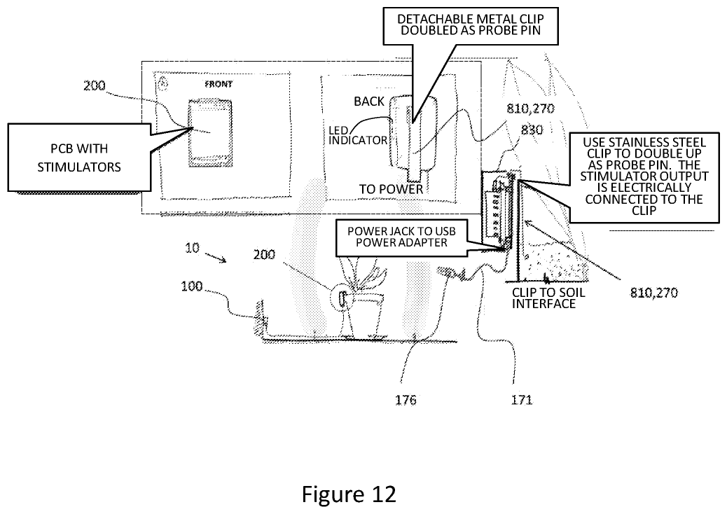

In some embodiments as illustrated in FIG. 12, one clip arm 810 may be configured to transmit the negative voltage pulse to the root portion of the plant. The clip arm is formed from a conductive material (e.g. stainless steel, and other metallic materials) and is electrically connected to the voltage pulse module 200. The clip arm 810 is of a suitable length such that one end of the clip arm 810 is positioned at a depth underneath the soil surface, when the voltage pulse module 200 is attached to the rim of the plant pot 22. The negative voltage pulse V_{OUT} generated by the voltage pulse module 100 is transmitted to the soil via the conductive clip arm 810. In other words, the clip arm 810 functions both as a means for attaching the voltage pulse module 100 to the plant pot 22 and as the stimulating probe 270 for applying the negative voltage pulse into the soil to stimulating the plant 20.

In some embodiments, the voltage pulse module 200 may be integrated with the plant pot 22. In some embodiments, the voltage pulse module 200 may be shaped and dimensioned to fit in a cavity on a customized plant pot 22. The form factor of the apparatus 10 is further reduced in this specific configuration.

It is to be appreciated that other means may be used for attaching the voltage pulse module 200 onto the plant pot 22, for example by using an adhesive material, and the components connected to the voltage pulse module 200 including the stimulating probe 270 and the power supply module 100 could be arranged accordingly.

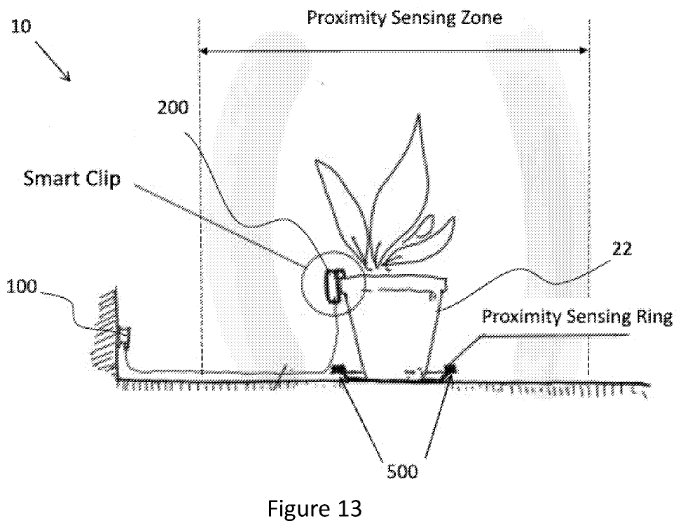

It is also to be appreciated that features and configurations of different functional modules of the various embodiments of the apparatus 10 as described above may be used in combination. For example, as shown in FIG. 13, the proximity sensors 500 may be mounted on the peripheral edge of a tray-like housing which holds plant pot 22 to provide a fencing zone, and the voltage pulse module 200 may configured to clip onto the plant pot 22.

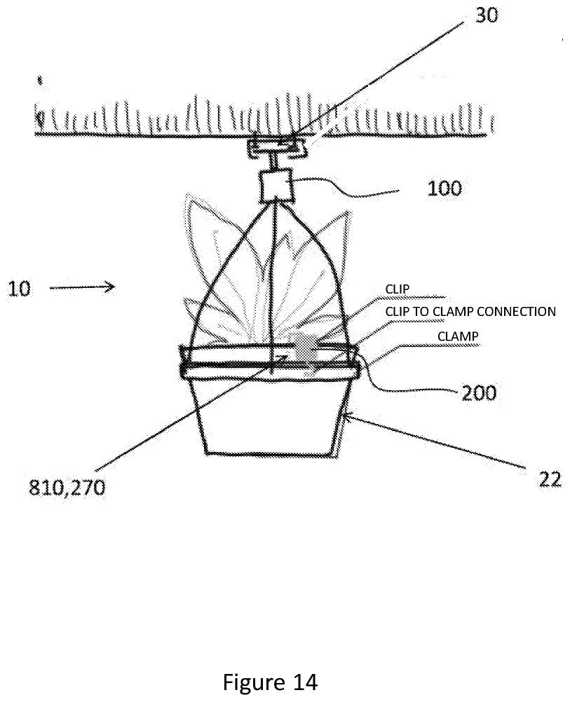

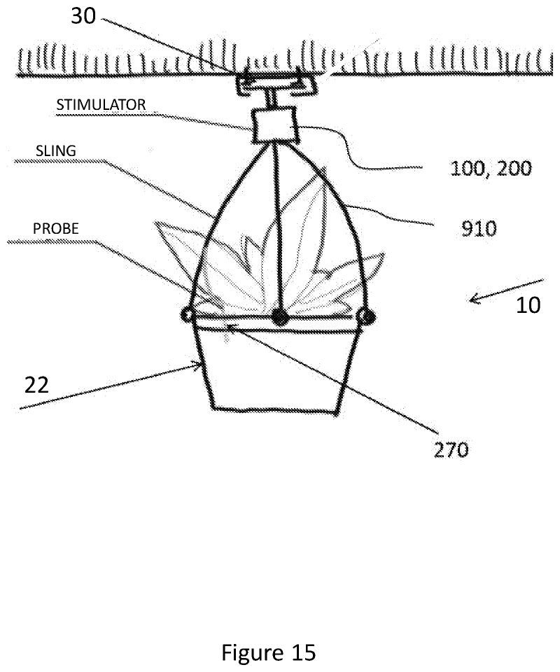

In some embodiments and with reference to FIG. 14 and FIG. 15, the apparatus 10 may be configured to connect to a power source 30 mounted on a ceiling surface, and a plurality of sling cables 910 are configured to hold the plant pot 22 in a suspended position.

With reference to FIG. 14, the power supply module 100 is connected to the power source 30, and the plurality of sling cables 910 are extended from the power supply module 100. At least one of the plurality of sling cables 910 is configured to transmit the pre-determined input voltage V_{IN} to the voltage pulse module 100. The voltage pulse module 100 may be configured to clip onto the plant pot 22 and one clip arm 810 may function as the stimulating probe 270 to transmit the negative voltage pulse V_{OUT} to the soil in the plant pot 22 for stimulating the plant.

With reference to FIG. 15, the power supply module 100 and the voltage pulse module 200 may be provided as one single unit, and the plurality of sling cables 910 are extended therefrom. At least one of the plurality of sling cables 910 is configured to transmit the negative voltage pulse V_{OUT} from the voltage pulse module 100 to the stimulating probe 270.

In accordance to a further aspect of the disclosure, there is provided a power supply device for use with the apparatus 10 for producing negative air ions.

In various embodiments, the power supply device 100 comprises a transformer 120 with a primary side 120-a and a secondary side 120-b, and a voltage stabilizing circuit 150 connected to the primary and secondary sides 120-a, 120-b so as to bridge an isolation gap of the transformer 120. A reflected voltage pulse from the voltage pulse module 200 of the apparatus 10 may be discharged via or clamped by the voltage stabilizing circuit 150. The power supply device 100 operates to deliver a stable and steady input voltage to the voltage pulse module 200.

The power supply device 100 is similar to the power supply module 100 as shown in FIGS. 4 to 14. Alternatively, the power supply device 100 is one embodiment of a power supply module 100 that is configured as an external power supply for the voltage pulse module 100 of the apparatus 10. Similar parts/similar electronic circuitry in the power supply device 100 have the same or similar reference numbers as those in the power supply module 100. The description of power supply module 100 of FIGS. 1 to 12 in accordance to difference embodiments also applies to the external power supply device 100.

The apparatus 10 may be used in various settings, including enterprises (e.g. in hospital suites, hotel rooms, enterprise offices and etc.) and households or home in-door (e.g. in living room, study room, bedroom, kitchen and etc.). For example, the apparatus 10 with an voltage pulse module 200 integrated on the plant pot 22 may be suitable for placing on a desk and/or at bedside when it is used with in-door air cleaning plants (e.g. snake plant, Areca palm and etc.) cultivated in small-size plant ports (e.g. a pot with a 15×15 cm base). The apparatus 10 of FIGS. 9 to 13 with the clip design may be adapted to fit in different standard commercial pots of different sizes. Plant pots of a relatively small size may be suitable for placing on desktop and bedside, while plant pots of larger sizes (such as large floor pots) may be used in hotel suites and living rooms. The apparatus 10 of different configurations are thus suitable for different room sizes, for example, a 10-20 m² room, a 20-30 m² room, or a 30-50 m² room.

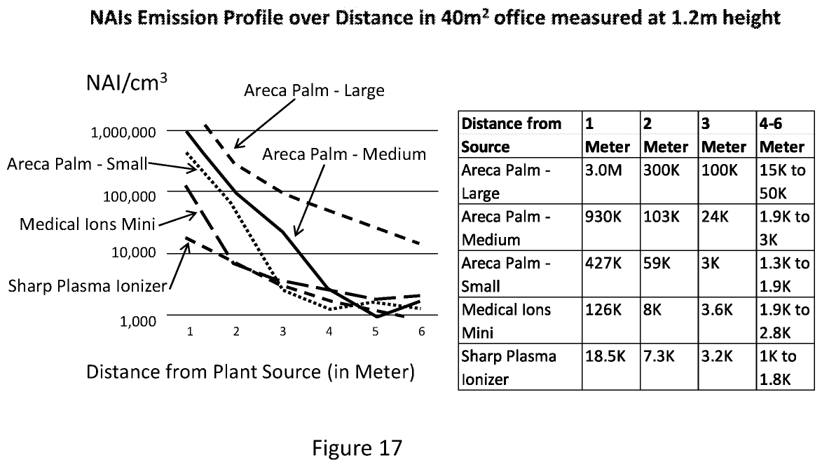

FIG. 17 illustrates the amount of negative air ions produced by using the apparatus 10. The apparatus 10 is used with Areca palm plants of three different sizes (i.e. small, medium, large) placed in a 40 m² office room. The apparatus 10 is set to produce negative voltage pulses of three different voltage levels (i.e. −7 kV, −14 kV and −18 kV) for stimulating the Areca palm plants of small, medium and large size respectively. The amount of negative air ions is measured at various distances from the plant. The apparatus 10 is capable of delivering about 400K to 3 million negative air ions at one meter from the plant source. At a distance of four to six meter from the plant source, the amount of negative air ions measured is at about 1.3K to 50K. The apparatus 10 is capable of producing a substantially higher amount of negative air ions than the two electrical ionizers from the market.

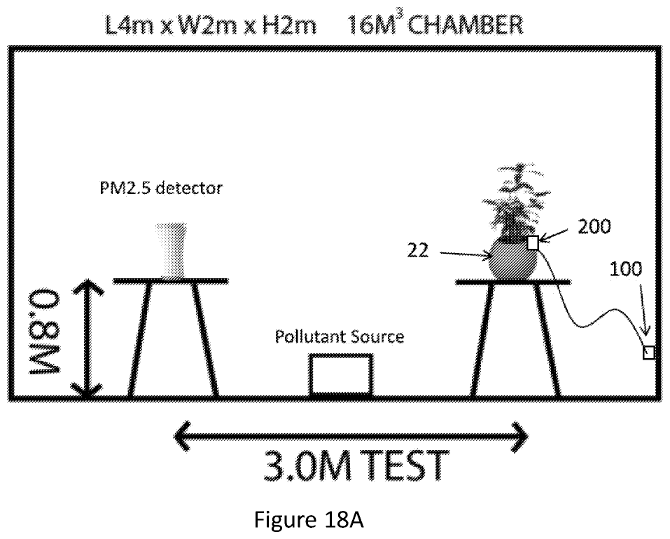

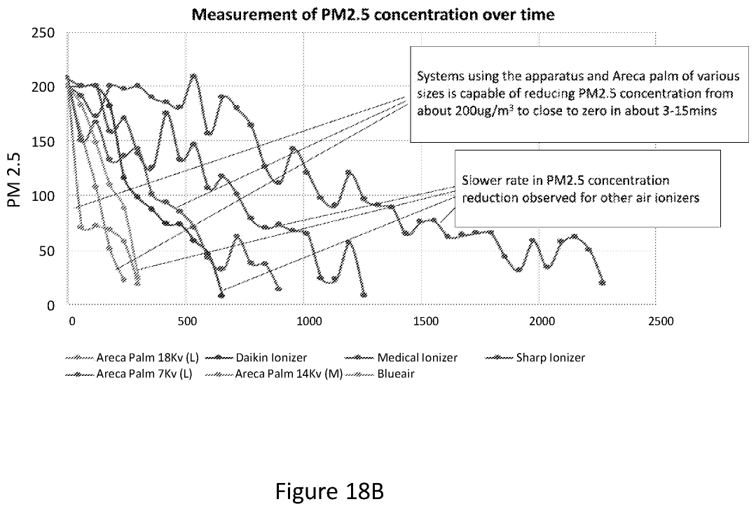

FIGS. 18A and 18B illustrate air cleaning efficiency of the apparatus 10, and more specifically the effect of reduction of PM2.5 concentration by using the apparatus 10. The measurement is conducted in a 16 m³ enclosed chamber, where a pollutant source fills the chamber with PM2.5 at a concentration of 200 ug/m³. The apparatus 10 is set to produce negative voltage pulses of three different voltage levels (i.e. −7 kV, −14 kV and −18 kV) for stimulating the Areca palm plants of small, medium and large size respectively. As the apparatus 10 is activated for producing negative air ions, concentration of PM2.5 at three meters from the plant source is measured/monitored at different timings. The apparatus 10 when used with the small size Areca palm plant is shown to remove at least 200 ug/m³ PM2.5 in the 15 minutes. When used with medium and/or large size Areca palm plant, the air cleaning efficiency is increased further, wherein PM2.5 pollutants in a concentration of 200 ug/m³ may be removed by the medium size Areca palm plant (stimulated at 14 kV by the apparatus 10) in 5 minutes and large size Areca palm plant (stimulated at 18 kV by the apparatus 10) in only 3 minutes. Substantial improvements in the air cleaning efficiency is observed when using the apparatus 10 as compared with the existing air purifiers and electrical ionizers.

The apparatus 10 of the present disclosure is shown to be capable of producing negative air ions and reducing particulate matter in the surrounding environment in an efficient manner. The apparatus 10 is also advantageous over existing system in that it is compatible with standard commercial plants of different types. In this regard, the apparatus 10 comprises adaptable structures for use with plant pots of different sizes. Such features include the tray-like/ring-like housing for receiving the plant pot, the clip for attaching to the side wall of plant pot, as well as the sling cables for holding the plant pot in the suspended position, as described in the various embodiments of the present disclosure.

As the power supply device 100 is capable of supplying a stable and steady input voltage to the voltage pulse module 200 without being affected by the load or any reflected voltage pulse from the voltage pulse module 200, no modification is required to ground the plant pot or the voltage pulse module 200 to the earth. Particularly, a voltage stabilizing circuit 150 is added in the power supply module 100, which may be implemented in the form of bleed resistors of a relatively high impedance, to bridge an isolation gap of the transformer. Variations in the power output can be effectively controlled/minimized by such voltage stabilizing circuit 150. In embodiments where the power supply module is configured to be connected to a three-pin power socket, modifications are made to the power supply module to connect a reference line at the transformer secondary side 120 (e.g. a chassis ground reference at the power output interface) to a grounding pin of the three-pin power socket. This provides for another discharge path for the undesirable electric field (e.g. the floating voltage), allowing the variations in the power output to be further reduced. Further, leakage current from the apparatus 10 is minimized by incorporating protection device into the power supply device 100, and occurrence of any electrical shock is prevented by forming a proximity sensing zone around the plant source. An efficient, safe and reliable negative air ion generation system is thus achieved.

### REFERENCE

10 apparatus
20 plant
22 plant pot
30 power source
100 power supply module/power supply device
120 transformer circuit
120-a primary side
120-b secondary side
125 control circuit
130 input rectifying and filtering circuit
131 bridge rectifier
132 capacitor
140 output rectifying and filtering circuit
150 voltage stabilizing circuit
153 resistor
156 transient voltage suppression (TVS) diode
170 power outlet interface
170a USB receptacle
171 power cable
176 USB connector
180 two-pin power inlet interface
190 three-pin power inlet interface
191 earth grounding pin
200 voltage pulse module
270 stimulating probe
300 communication module
400 display module
450 touch sensing module
500 proximity sensing module
510 proximity sensor
600 controller
620 FFC (Flexible Flat Cable) circuit
700 housing
710 first surface
800 clip
810 clip arm
830 casing
910 sling cable

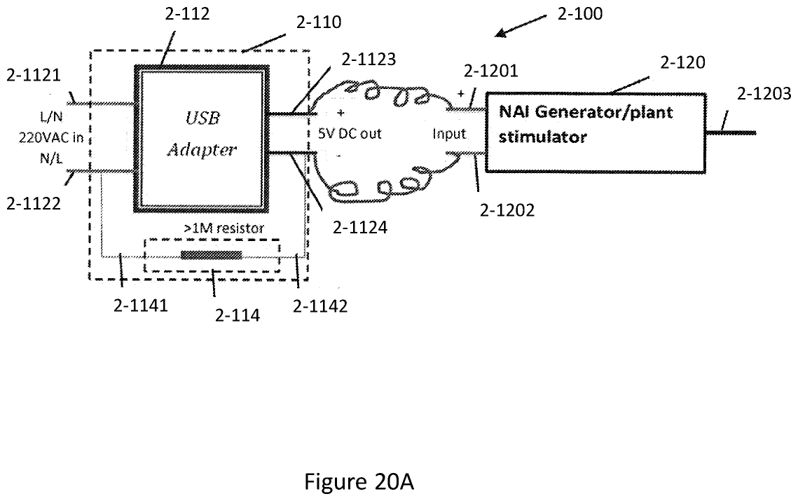

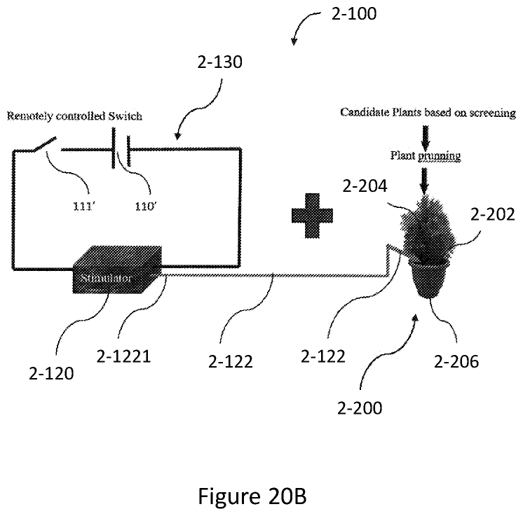

A second embodiment of the invention is depicted in FIG. 20A. FIG. 20A shows a schematic diagram of a plant stimulation apparatus 2-100 in an example scenario of negative air ion (NAI) generation. The plant stimulation apparatus 2-100 includes a universal power adapter 2-110 and a plant stimulator 2-120. The universal power adapter 2-110 includes an alternating current to direct current (AC-DC) power converter 2-112 and a resistive portion 2-114 connected electrically across the AC-DC power converter 2-112.

The AC-DC power converter 2-112 in this example is compliant with the universal serial bus (USB) specifications and is configured to convert an AC input signal of 220V into a DC output signal of 5V. In other words, output terminals for outing the DC output signal is in the form of a USB output port. In other examples, each of the AC input signal and the DC output signal may have other voltages. For instance, the AC input signal may have a voltage of 110V and the DC output signal may have a voltage of 12V. The AC-DC power converter 2-112 includes electrical contacts such as live and neutral input pins 2-1121, 2-1122 to receive the AC input signal for conversion by the AC-DC power converter 2-112 into the DC output signal. The live and neutral input pins 2-1121, 2-1122 are thus respectively coupled electrically to the live and neutral power conductors of an AC power source. The universal power adapter further includes output terminals in the form of current supply and current return pins 2-1123, 2-1124 connected electrically to the plant stimulator 2-120 to provide the DC output power signal to the plant stimulator 2-120. In this example, a voltage at the current supply pin 2-1123 is higher than a voltage at the current return pin 2-1124 to cause the DC output signal to flow from the current supply pin 2-1123 to the current return pin 2-1124 through the plant stimulator 2-120.

The resistive portion 2-114 provides a resistive path across the AC-DC power converter 2-112. The resistive portion 2-114 include a first end 2-1141 connected electrically to the neutral input pin 2-1122 and a second end 2-1142 connected electrically to the current return pin 2-1124. In another example (not shown), however, the first end 2-1141 of the resistive portion 2-114 may be connected electrically to the live input pin 2-1121 instead of the neutral input pin 2-1122.

The resistive portion 2-114 is configured to limit passage of the received AC input signal (specifically the alternating current (AC)) through the resistive portion 2-114 while facilitating passage of residual charge from the plant stimulator 2-120 via the resistive portion 2-114. The residual charge might be any static charge generated by the plant stimulator in the course of causing a potted plant to generate negative ions or perhaps any residual ions from the ion generation. The resistive portion 2-114 in this example has a resistance of 1 megaohm (MΩ), more particularly includes a resistor of 1 MΩ. However, the resistor may have any other resistance greater than or lower than 1MΩ in other examples as long as the resistor may limit the AC flow from the AC side to the DC side. In addition, the resistive portion 2-114 may include any other resistive component in place of or in conjunction with the resistor, provided that the resultant resistance of the resistive portion 2-114 is at least 1MΩ (e.g., 2 MΩ or 3 MΩ) in this exemplary embodiment. The resistive path provided by the resistive portion 2-114 may also be referred to as a “return path”. Moreover, the AC-DC power converter 2-112 can be implemented using any commercially available USB power adapter, and the resistive portion 2-114 can be operatively associated with the AC-DC power converter 2-112 without requiring any changes to component parameters of the AC-DC power converter 2-112. Thus, an off-the-shelf AC-DC power converter might be retrofitted with such a resistive portion. Moreover, it should be noted that the resistive portion 2-114 may have a resistance of less than 1 MΩ, provided that the resistive portion 2-114 sufficiently limits passage of the received AC input signal through the resistive portion 2-114 while sufficiently facilitating passage of residual charge such as residual ions from the plant stimulator 2-120 via the resistive portion 2-114. Thus, the resistive portion 2-114 functions as an AC current limiter.

It has been found that using the AC side or the power line as a return path for residual charge helps to reduce static charge on plants (as the plants are stimulated by a plant stimulator to generate negative ions). Since the preferred embodiment uses either the live or neutral pin as a return path, this eliminates a need to relying on a third earth ground pin which may not be ubiquitous. Thus the preferred embodiment is able to address the arching or static effect without having to rely on the earth grounding pin, and instead relies on either the live or the neutral connections. Thus, the universal power adapter 2-110 may only have two pins (i.e. taking the form of a 2-pin plug or adapter) or may have three pins (including the earth grounding pin but not relevant/used in this particular embodiment).

It should be appreciated that the resistive portion 2-114 may not form part of the AC-DC power converter 2-112 and may be external to the circuitry which forms the AC-DC power converter 2-112. Needless to say, there may be a housing to house the resistive portion 2-114 and the AC-DC power convert 2-112 and with the live and neutral input pins 2-1121, 2-1122 and current supply and current return pins 2-1123, 2-1124 accessible or connectable of course.

According to an alternative example (not shown), the universal power adapter 2-110 may be substituted by a power supply device (e.g., a battery or a solar panel). The power supply device may include a DC power source with current supply and current return pins similar in configuration to those 2-1123, 2-1124 of the AC-DC power converter 2-112 to provide a DC output signal from the DC power source to the plant stimulator 2-120. That is, the current supply and current return pins of this alternative example may be connected electrically to the input pins 2-1201, 2-1202 of the plant stimulator 2-120 to provide the DC output signal from the DC power source to the plant stimulator 2-120. The power supply device may further include a resistive portion including a first end connected electrically to ground and a second end connected electrically to the current return pin. That is, the resistive portion of the alternative example differs from that 2-114 of FIG. 20A in that, in the alternative example, the first end of the resistive portion is connected electrically to ground rather than to a live input pin or a neutral input pin. The resistive portion of this alternative example may be configured to facilitate passage of residual charge from the plant stimulator 2-120 via the resistive portion. In such a configuration, the resistive portion may be regarded as providing a “grounding path”.

Operation of the plant stimulator 2-120 can be understood with reference to the below description of FIG. 20B, which shows a plant stimulator implemented in the form of a pulse generator. Representative or exemplary embodiments describe an apparatus 2-100 for generating negative air ions from plants. As used herein, the apparatus 2-100 refers to a setup or a set of equipment operative for generating negative air ions. Particularly, the apparatus 2-100 comprises a portable device 2-130 and a potted plant 2-200. The portable device 2-130 is an electronic device that is co-operable with the potted plant 2-200 for generating negative air ions. The potted plant 2-200 comprises a planter or container 2-206 (e.g. pot, box, vase, or vessel), soil 2-202 disposed in the container 2-206, and one or more plants 2-204 grown on the soil 2-202. The plants 2-204 are of various species, namely terrestrial plant species and hydrophytic/aquatic plant species. Furthermore, the plants 2-204 may be flowering plants or non-flowering plants, such as ferns. The plants 2-204 may be screened and selected based on various factors, such as their ability to generate or release negative air ions, as described below. As the apparatus 2-100 relies on the biology mechanisms of the plants 2-204 to generate negative air ions, the apparatus 2-100 may also be referred to as a bio-generator.

The portable device 2-130 is configured for use with the plants 2-204 in the potted plant 2-200 for generating negative air ions from the plants 2-204. The portable device 2-130 is designed to be easily transported, i.e. carried or moved, by a person. The portable device 2-130 comprises a pulse generator 2-120 for generating voltage pulses from an internal operating frequency ranging from 18 kHz to 48 kHz. Additionally, the voltage pulses have an output pulse frequency that ranges from 0.02 kHz to 40 kHz. For example, the output pulse frequency may range from 0.02 kHz to 5 kHz, or from 5 kHz to 40 kHz, depending on the configuration/circuitry of the pulse generator 2-120 and/or on the internal operating frequency. The pulse generator 2-120 is an electronic machine configured to generate rectangular pulses of predefined voltage levels, i.e. voltage pulses. The pulse generator 2-120 may thus be referred to as a voltage source. The pulse generator 2-120 generates or outputs voltage pulses with an output ranging from 1 kV to 40 kV. Preferably, the output ranges from 15 kV to 40 kV. In some experiments, the output is 20 kV in an open circuit at 50 μA with an internal operating frequency of 48 kHz. In some experiments, the output is 30 kV in an open circuit at 80 μA with an internal operating frequency ranging from 18 kHz to 35 kHz. In some embodiments, the output is 7 kV and an experiment was performed on the plant species Dracena surculosa to remove particulate matter, as described further below.

The portable device 2-130 further comprises a pulse probe 2-122 for coupling the pulse generator 2-120 to the plants 2-204 in the potted plant 2-200. Specifically, the pulse probe 2-122 comprises a proximal end 2-1221 connected to an output terminal of the pulse generator 2-120, and a distal end 2-1222 insertable into the soil 2-202 in the potted plant 2-200. For example, the distal end 2-1222 is inserted 10 cm deep into the soil 2-202. The pulse probe 2-122 is configured for conducting the voltage pulses from the pulse generator 2-120 to the plants 2-204. Specifically, the pulse probe 2-122 conducts the voltage pulses from the pulse generator 2-120 (whereto the proximal end 2-1221 is connected) to the soil 2-202 (wherein the distal end 2-1222 is inserted). The pulse probe 2-122 including its proximal end 2-1221 and distal end 2-1222 can be manufactured in various designs and shapes, such as to make it easier to operate by the user.

In some embodiments, the portable device 2-130 is separately located from the potted plant 2-200 and the pulse probe 2-122 extends across some distance and inserts into the soil 2-202. In some other embodiments, the portable device 2-130 is integrated with the planter 2-200, such as by a coupling mechanism with the container 2-206. The pulse probe 2-122 extends across a shorter distance and inserts into the soil 2-202.

The plants 2-204 generate and release negative air ions in response to the conducting of the voltage pulses to the plants 2-204. Although the plants 2-204 naturally release negative air ions, the generation of negative air ions is enhanced or improved because of the voltage pulses. Specifically, the pulse probe 2-122 generates a pulsed electric field in response to the conducting of the voltage pulses from the pulse generator 2-120 to the soil 2-202. The pulsed electric field stimulate the roots of the plants 2-204 grown inside the soil 2-202, thereby stimulating or enhancing generation of negative air ions from the plants 2-204. To reduce interference to the pulsed electric field, the potted plant 2-200 may be placed on an elevated base made of an electrical insulation material. The container 2-206 may also be made of a similar electrical insulation material.

The portable device 2-130 further comprises a portable power source 2-110 for powering the pulse generator 2-120. In some embodiments, the portable power source 2-110 comprises a set of batteries arranged in parallel. The batteries may be standard alkaline batteries or rechargeable batteries. In one embodiment, the power source 2-110 comprises a single 9-volt DC battery. In another embodiment, the power source 2-110 comprises six 9-volt DC batteries arranged in parallel. In some other embodiments, the power source 2-110 comprises one or more 12-volt DC batteries. In some other embodiments, the power source 2-110 is rechargeable, such as by plugging the portable device 2-130 to a power outlet or socket, to a Universal Serial Bus (USB) port of a computer, or to a power bank. It will be appreciated that suitable types of rechargeable batteries may be used for the power source 2-110, such as lithium-ion batteries. In some other embodiments, the power source 2-110 may include a power converter or transformer for converting AC power (from a power outlet/socket) to DC power.

In some embodiments with reference to FIG. 20B, the portable device 2-130 comprises a switch 2-111 for activating and deactivating the pulse generator 2-120. Accordingly, the switch 2-111 turns on and off the flow of electrical power from the portable power source 2-110 to the pulse generator 2-120. The portable device 2-130 may further comprise a wireless communication module connected to the switch 2-111 and communicable with an electronic device. This electronic device may be a mobile device, e.g. mobile phone, or a remote control for remotely controlling the portable device 2-130. Specifically, the electronic device is configured for remotely activating and deactivating the pulse generator 2-120 by switching on and off the portable power source 2-110. The wireless communication module may communicate with the electronic device by known wireless communication protocols, such as Bluetooth, Wi-Fi, NFC, infrared, RF, etc.

Operation of the pulse generator 2-120 in the apparatus 2-100 is similar to or representative of that of the plant stimulator 2-120 in the apparatus 2-100. Indeed, the power source 2-110 may take the form of the universal power adapter 2-110 described earlier to provide the required DC output power for the plant stimulator 2-120 (i.e. the pulse generator 2-120). With the resistive portion 2-114, this provides a return path for residual charge to be returned to the main power line and serves to improve the negative air ion generation performance of the plant 2-204 irrespective of the voltage of the DC output signal and also helps to minimize arcing or static discharge, which makes the potted plant 2-200 more amiable to be placed in public places without having someone coming into contact with the plant getting a rude shock.

In an alternative implementation involving a three-pin source of the AC input signal, the first pin 2-1141 of the resistive portion 2-114 may be connected electrically to a ground pin of the AC power source, with the second pin 2-1142 of the resistive portion 2-114 connected electrically to the current return pin 2-1124. This technique may be used to design a conversion plug to modify an existing USB power adapter to for powering a plant stimulator to generate negative air ions. As an example, the USB power adapter, which has three input pins and thus, a third grounding pin and the third grounding pin may be connected to an output negative electrode of the DC output via the resistive portion.

A three pin plug may also be used for a two poles socket or AC power supply. For instance, a plug converter and a USB power adapter can be used together. The plug converter 410 can be a Type F (two pins) and the USB power adapter can be a Type G (three pins). The USB power adapter can be modified to have a resistive portion connected across the live pin or the neutral pin on the input side, and the current return pin on the output side. The USB power adapter thus can be provided with a return path. When plugged into the plug converter, the USB power adapter can be used in the plug type region of the plug converter whilst achieving the advantageous effects described above in relation to the arrangement of FIG. 20A. This technique of modified conversion plug is applicable to a plant stimulation apparatus with a universal power adapter of two pins, and allows the plant stimulation apparatus to be used in regions of different plug types.

The resistive portion in the example of the universal power adapter 2-100 and that in the example of the power supply device are advantageous. For example, the resistive portion reduces the occurrence of arcing and/or the occurrence of electrostatic shock when the plant 2-204 is touched. That is, the resistive portion facilitates passage of residual charge from the plant stimulator 2-120 through the resistive portion, more particularly from the associated plant through the plant stimulator 2-120 via the resistive portion, thereby reducing (or preventing) electric charge creation in the associated plant and reducing (or preventing) electrostatic shock occurrence (i.e., an electrostatic discharge). In addition, by virtue of the resistive portion 2-114, the apparatus 2-100, more particularly the universal power adapter 2-110, is suitable for use with a two-pin source (e.g., a two-pin power socket) of the AC input signal that has no ground connection (e.g., due to power supply restrictions or power socket designs). In other words, by virtue of the resistive portion 2-114, the apparatus 2-100 or the universal power adapter 2-110 is suitable for use with a broader range of sources (e.g., power sockets) of the AC input signal, including not only three-pin sources (with an earth ground pin) but also two-pin sources (without an earth ground pin). Moreover, the resistive path (or the return path) serves to improve the negative air ion generation performance of the plant 2-204 irrespective of the voltage of the DC output signal.

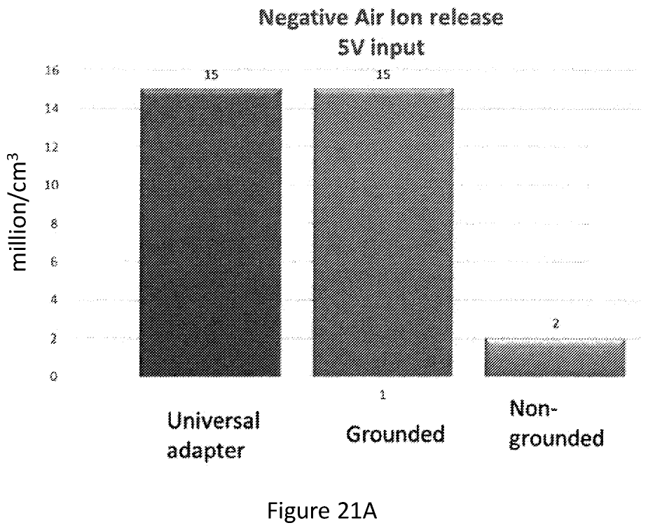

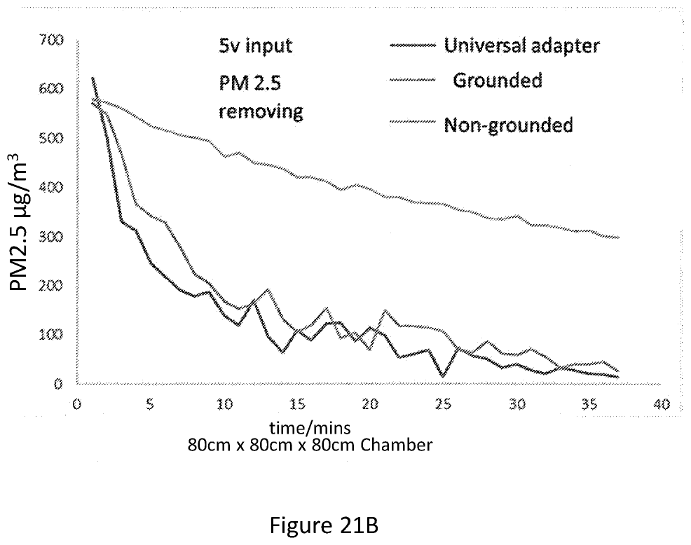

FIG. 21A, 21B show measurement results of negative air ion release.

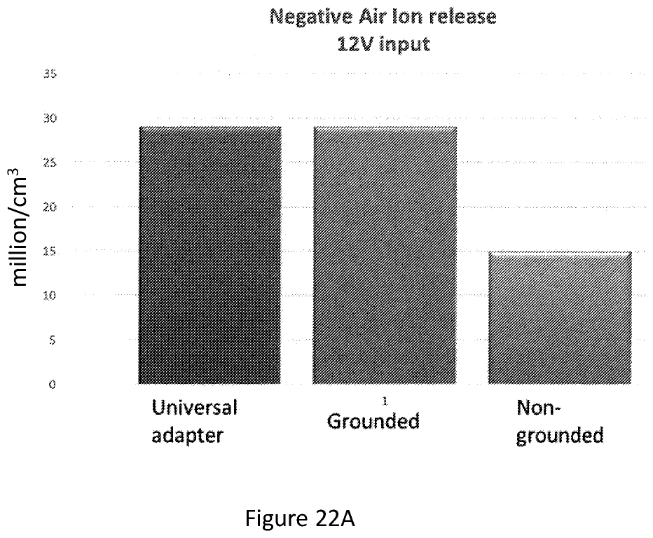

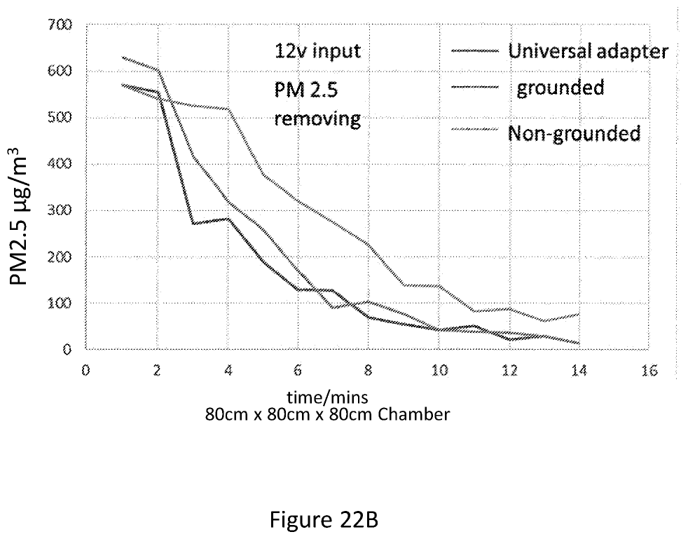

FIG. 22A, 22B show measurement results of PM 2.5 removal.

Potential applications of the invention include, for example, airport smoking rooms, building smoking areas, general air cleaning for cities, homes, offices, all sorts of enclosed spaces where reduction of air pollution (e.g., PM2.5) is desired. Additionally, by virtue of the resistive portion 2-114 and its effect of electrostatic shock reduction, the invention is particularly suitable for use in scenarios where the plant is likely to come into contact with people or pets/animals.

It is worth noting that the invention can also be used for stimulating a plant for purposes other than negative air ion generation. While it is preferred for stimulating a potted plant, the described embodiment may power an apparatus for generating negative air ions from plants, air ionizers or as a common USB power source.

The term “pin” as used herein may be interpreted to mean “terminal” or more generally an electrical contact or the like.

The term “residual charge” as used herein may refer to electric charge remaining in the plant during stimulation and causing an electrostatic shock upon discharge (e.g., when touched by a persons hand) and might also include any residual ions generated by the plant.

It is to be appreciated by the person skilled in the art that variations and combinations of features described above, not being alternatives or substitutes, may be combined to form yet further embodiments falling within the intended scope of the disclosure.

1. An apparatus for producing negative air ions from a plant, comprising:
a power supply module, wherein the power supply module comprises a transformer with a primary side and a secondary side, and a voltage stabilizing circuit connected to both the primary side and the secondary side so as to bridge an isolation gap of the transformer;
a voltage pulse module connectable to the power supply module, the power supply module being configured to provide a pre-determined input voltage V_{IN} to the voltage pulse module for generating a negative voltage pulse, and to adjust a reflected voltage pulse from the voltage pulse module; and
a stimulating probe connected to the voltage pulse module and configured to transmit the negative voltage pulse to a root portion of the plant.

2. The apparatus according to claim 1, wherein the voltage stabilizing circuit comprises one or more bleed resistors of a pre-determined resistance value.

3. The apparatus according to claim 2, wherein a lower limit of the resistance value of the one or more bleed resistors is determined based on a perceptible threshold of leakage current strength, and an upper limit of the resistance value of the one or more bleed resistors is determined based on an operational condition of the transformer.

4. The apparatus according to claim 2, wherein the voltage stabilizing circuit further comprises a circuit protection device.

5. The apparatus according to claim 1, wherein the power supply module comprises a power outlet interface for connecting to a power cable configured to transmit the input voltage V_{IN} to the voltage pulse module.

6. The apparatus according to claim 5, wherein the power outlet interface is a USB receptacle configured to receive a USB connector of the power cable.

7. The apparatus according to claim 1, wherein the power supply module comprises a power inlet interface configured to connect to a two-pin power socket, and/or a three-pin power socket.

8. The apparatus according to claim 7, wherein a reference line at the secondary side of the transformer is connected to an earth grounding pin of the three-pin power socket.

9. The apparatus according to claim 1, further comprising a proximity sensing module configured to detect an intruding subject in the vicinity of the plant.

10. The apparatus according to claim 9, wherein the proximity sensing module comprises one or more of the following proximity sensors: active infrared proximity sensor, passive infrared proximity sensor, radio frequency proximity sensor, laser proximity sensor, time-of-flight (ToF) proximity sensor, inductive proximity sensor, capacitive proximity sensor.

11. The apparatus according to claim 1, further comprising a touch sensing module configured to detect a subject coming in contact with the plant.

12. The apparatus according to claim 9, further comprising a controller configured to control operation of the apparatus based on data from the proximity sensing module or from the touch sensing module.

13. The apparatus according to claim 1, wherein the apparatus comprises a housing configured to contain at least the voltage pulse module and to receive a plant pot.

14. The apparatus according to claim 13, wherein the first surface comprises a concave portion sized and shaped to receive a bottom part of the plant pot.

15. The apparatus according to claim 13, wherein the apparatus comprises at least two proximity sensors mounted on a peripheral edge of the housing in a symmetrical manner for forming a proximity sensing zone.

16. The apparatus according to claim 1, wherein the voltage pulse module is configured to attach to a side wall of a plant pot.

17. The apparatus according to claim 16, wherein the voltage pulse module is shaped and dimensioned to fit in a cavity on the plant pot.

18. The apparatus according to claim 17, wherein the voltage pulse module comprises a clip for attaching to the side wall of the plant pot.

19. The apparatus according to claim 18, wherein one clip arm of the clip is configured to transmit the negative voltage pulse to the root portion of the plant.

20. The apparatus according to claim 1, wherein the apparatus is configured to connect to a power source mounted on a ceiling surface, and a plurality of sling cables are configured to hold a plant pot in a suspended position, wherein at least one of the plurality of sling cables is configured to transmit the predetermined input voltage V_{IN} from the power supply module to the voltage pulse module.

21. The apparatus according to claim 1, wherein the apparatus is configured to connect to a power source mounted on a ceiling surface, and a plurality of sling cables are configured to hold a plant pot in a suspended position, wherein at least one of the plurality of sling cables is configured to transmit the negative voltage pulse from the voltage pulse module to the stimulating probe.

22. The apparatus according to claim 1, wherein the pre-determined input voltage V_{IN} is between 3.3V and 100V.

23. The apparatus according to claim 1, wherein a voltage level of the negative voltage pulse is between −2 kV and −48 kV.

24. A power supply device for use in the apparatus according to claim 1 as the power supply module, wherein the voltage stabilizing circuit comprises one or more bleed resistors of a pre-determined resistance value.

25. The power supply device according to claim 24, wherein a lower limit of the resistance value of the one or more bleed resistors is determined based on a perceptible threshold of leakage current strength, and an upper limit of the resistance value of the one or more bleed resistors is determined based on an operational condition of the transformer.

26. The power supply device according to claim 25, wherein the voltage stabilizing circuit further comprises a circuit protection device.

27. The power supply device according to claim 24 further comprising at least one of:
an input rectifying and filtering circuit at the primary side; and
an output rectifying and filtering circuit at the secondary side.

28. The power supply device according to claim 24 further comprising a power outlet interface for connecting to a power cable configured to transmit the input voltage V_{IN} to the voltage pulse module.

29. The power supply device according to claim 28, wherein the power outlet interface is a USB receptacle configured to receive a USB connector of the power cable.

30. The power supply device according to claim 24 further comprising a power inlet interface for connecting to a two-pin power socket, and/or a three-pin power socket.

31. The power supply device according to claim 30, wherein a reference line at the secondary side of the transformer is connected to an earth grounding pin of the three-pin power socket.

32. The power supply device according to claim 24, wherein the power supply device is configured to derive a predetermined input voltage V_{IN} of between 3.3V and 100V for the voltage pulse module.

33. A plant stimulation apparatus comprising:
(a) a plant stimulator arranged to electrically stimulate a potted plant to cause the potted plant to generate negative ions; and
(b) a universal power adapter comprising:
first and second electrical contacts adapted to receive an alternative current (AC) power signal from respective live and neutral power conductors of an AC power source;
current supply and current return electrical terminals for outputting a direct current (DC) power signal to the plant stimulator;
an AC-DC power converter arranged to convert the AC power signal into the DC power signal; and
a resistive portion electrically coupled between either the first and second electrical contacts and to the current return electrical terminal of the DC power signal, the resistive portion being configured to limit passage of the received AC power signal through the resistive portion while facilitating passage of residual charge from the plant stimulator via the resistive portion.

34. A plant stimulation apparatus comprising:
(a) a plant stimulator arranged to electrically stimulate a potted plant to cause the potted plant to generate negative ions; and
(b) a power supply device for powering the plant stimulator, the device comprising:
a DC power source;
current supply and current return terminals adapted to provide a DC output signal from the DC power source to the plant stimulator; and
a resistive portion having a first end connected electrically to ground and a second end connected electrically to the current return terminal, the resistive portion being configured to facilitate passage of residual charge from the plant stimulator via the resistive portion.

35. A kit comprising:
(a) a plant stimulator arranged to electrically stimulate a potted plant to cause the potted plant to generate negative ions;
(b) a universal power adapter for powering the plant stimulator, the adapter comprising:
first and second electrical contacts adapted to receive an alternative current (AC) power signal from respective live and neutral power conductors of an AC power source;
current supply and current return electrical terminals for outputting a direct current (DC) power signal to the plant stimulator;
an AC-DC power converter arranged to convert the AC power signal into the DC power signal; and
a resistive portion electrically coupled between either of the first and second electrical contacts and to the current return electrical terminal of the DC power signal, the resistive portion being configured to limit passage of the received AC power signal through the resistive portion while facilitating passage of residual charge from the plant stimulator via the resistive portion; and
(c) a cable adapted for electrical connection between the universal power adapter and the plant stimulator.

36. A kit comprising:
(a) a plant stimulator arranged to electrically stimulate a potted plant to cause the potted plant to generate negative ions;
(b) a universal power adapter for powering the plant stimulator, the adapter comprising:
two or more electrical contacts adapted to receive an alternative current (AC) power signal from respective power conductors of an AC power source;
current supply and current return electrical terminals for outputting a direct current (DC) power signal to the plant stimulator;
an AC-DC power converter arranged to convert the AC power signal into the DC power signal; and
a resistive portion electrically coupled between one of the electrical contacts and the current return electrical terminal of the DC power signal, the resistive portion being configured to limit passage of the received AC power signal through the resistive portion while facilitating passage of residual charge from the plant stimulator via the resistive portion; and
(c) a cable adapted for electrical connection between the universal power adapter and the plant stimulator.

37. The kit according to claim 36, wherein the two or more electrical contacts of the universal power adapter include three electrical contacts arranged to be connected to ground, live and neutral power conductors, and wherein the resistive portion is connected to the electrical contact to be connected to the ground conductor.

38. The kit according to claim 35, further comprising the potted plant.

39. A kit comprising:
(a) a plant stimulator arranged to electrically stimulate a potted plant to cause the potted plant to generate negative ions;
(b) a power supply device for powering the plant stimulator, the device comprising:
a DC power source;
current supply and current return terminals adapted to provide a DC output signal from the DC power source to the plant stimulator; and
a resistive portion having a first end connected electrically to ground and a second end connected electrically to the current return terminal, the resistive portion being configured to facilitate passage of residual charge from the plant stimulator via the resistive portion; and
(c) a cable adapted for electrical connection between the power supply device and the plant stimulator.

40. The kit according to claim 39, further comprising the potted plant.

41.-47. (canceled)
